(19) United States
(12) Patent Application Publication
(10) Pub. No.: US 2024/0406837 A1
(43) Pub. Date: Dec. 5, 2024

(54) ELECTRONIC DEVICE SUPPORTING DUAL CONNECTIVITY, AND OPERATION METHOD THEREFOR

(71) Applicant: SAMSUNG ELECTRONICS CO., LTD., Suwon-si (KR)

(72) Inventors: Junsuk KIM, Suwon-si (KR); Taeyoon KIM, Suwon-si (KR); Hyoungjoo LEE, Suwon-si (KR); Euichang JUNG, Suwon-si (KR); Chaiman LIM, Suwon-si (KR)

(73) Assignee: SAMSUNG ELECTRONICS CO., LTD., Suwon-si (KR)

(21) Appl. No.: 18/799,200

(22) Filed: Aug. 9, 2024

Related U.S. Application Data
(63) Continuation of application No. PCT/KR2023/001421, filed on Jan. 31, 2023.

(30) Foreign Application Priority Data
Feb. 11, 2022 (KR) 10-2022-0018460
Mar. 15, 2022 (KR) 10-2022-0032249

(51) Int. Cl. H04W 40/22; H04W 28/02; H04W 52/14; H04W 76/15; H04W 76/20

(52) U.S. Cl. CPC H04W 40/22; H04W 28/0278; H04W 52/146; H04W 76/15; H04W 76/20

(57) ABSTRACT

An electronic device includes: communication circuitry; one or more processors; and memory storing instructions that, when executed by the one or more processors individually or collectively, cause the electronic device to: select one of a transmission path based on a first radio access technology (RAT) and a transmission path based on a second RAT as a first transmission path, wherein the first transmission path is an uplink data transmission path to be used in the electronic device for a dual connectivity communication, perform, via the communication circuitry, an operation of stopping uplink data transmission and maintaining uplink control information transmission on a second transmission path other than the first transmission path among the transmission path based on the first RAT and the transmission path based on the second RAT, and perform, via the communication circuitry, an operation of transmitting at least one of uplink data or uplink control information on the first transmission path.

### CROSS-REFERENCE TO RELATED APPLICATIONS

This application is a by-pass continuation application of International Application No. PCT/KR2023/001421, filed on Jan. 31, 2023, which is based on and claims priority to Korean Patent Application Nos. 10-2022-0018460, filed on Feb. 11, 2022, and 10-2022-0032249, filed on Mar. 15, 2022, in the Korean Intellectual Property Office, the disclosures of which are incorporated by reference herein their entireties.

### BACKGROUND

### 1. Field

The disclosure relates to an electronic device for supporting dual connectivity and an method thereof.

### 2. Description of Related Art

A 5^{th} generation (5G) system based on a 5G mobile communication standard (e.g., a new radio (NR) standard) proposed by a 3^{rd} generation partnership project (3GPP) may interwork with a 4th generation (4G) system based on a 4G mobile communication standard (e.g., a long-term evolution (LTE) standard). The 5G system may support a standalone (SA) structure in which the 5G system operates alone, and a non-standalone (NSA) structure in which the 5G system interworks with the 4G system. In the NSA structure, an E-UTRA NR dual connectivity (EN-DC) scheme may be supported. For example, in the EN-DC scheme, the 4G system may be used as a primary system and the 5G system may be used as a secondary system.

In the EN-DC scheme, a bearer structure for a transmission path for a communication between an electronic device (e.g., a user equipment (UE)) and a network may have various bearer types and protocol architectures according to a transmission path, a protocol type of a packet data convergence protocol (PDCP) entity, and/or a location of a PDCP protocol stack. In the EN-DC scheme, a master cell group (MCG) bearer, a secondary cell group (SCG) bearer, and/or a split bearer may be supported.

The MCG bearer may be a bearer associated with a transmission path to the 4G system. In the MCG bearer, entities (e.g., a radio link control (RLC) entity, a medium access control (MAC) entity, and/or a physical (PHY) entity) other than the PDCP entity which may use both the 4G standard and the 5G standard may use a 4G protocol stack based on the 4G standard.

The SCG bearer may be a bearer associated with a transmission path to the 5G system. In the SCG bearer, the PDCP entity, the RLC entity, the MAC entity, and/or the PHY entity may use a 5G protocol stack based on the 5G standard.

The split bearer may be a bearer associated with the transmission path to the 4G system and the transmission path to the 5G system. In the split bearer, the PDCP entity, the RLC entity, the MAC entity, and/or the PHY entity may use the 4G protocol stack and the 5G protocol stack. In the split bearer, the transmission path to the 4G system and the transmission path to the 5G system may be used simultaneously, so a data rate may be increased.

For an uplink split bearer, a PDCP entity may perform a transmitting operation based on threshold data volume and a sum of data volume (e.g., data amount) of the PDCP entity, data volume of an RLC entity associated with a primary path (e.g., the transmission path to the 4G system), and data volume of an RLC entity associated with a secondary path (e.g., the transmission path to the 5G system). As such, in the uplink split bearer, the data volume of the PDCP entity is reflected in both the primary path and the secondary path and then the transmitting operation is performed, and the data volume of the PDCP entity is reflected redundantly in both the primary path and the secondary path, so more uplink radio resources may be required than actual amount of uplink radio resources required for uplink data transmission. In this case, there may be surplus uplink radio resources which exceed amount of uplink radio resources required for an actual uplink transmitting operation, and the surplus uplink radio resources may not only reduce resource efficiency of the overall system, but also cause unnecessary transmission (e.g., padding data transmission). Such unnecessary transmission may not only cause waste of transmission power, but also increase signaling overhead of the overall system.

For the uplink split bearer, a dynamic power sharing (DPS) scheme may be used to efficiently manage transmission power for the primary path and transmission power for the secondary path. In the DPS scheme, the transmission power for the primary path may be preferentially allocated, and the transmission power for the secondary path may be allocated within transmission power excluding the transmission power allocated for the primary path among the total transmission power. The transmission power allocated for the secondary path may be limited according to the transmission power allocated for the primary path, so smaller transmission power may be allocated for the secondary path compared to transmission power actually required for the secondary path. In this case, a power scale down operation may be performed according to the overall transmission power limit based on dual connectivity, and if a transmitting operation is performed with the transmission power smaller than the transmission power actually required for the secondary path according to the power scale down operation, transmission failure may occur repeatedly. The repeated transmission failures may cause repetitive retransmitting operations, and the repetitive retransmitting operations may not only cause waste of transmission power, but also cause a pending phenomenon in which a receiving device (e.g., a base station) waits for reception of corresponding uplink data.

### SUMMARY

According to an aspect of the disclosure, an electronic device includes: communication circuitry; one or more processors comprising processing circuitry; and memory storing instructions that, when executed by the one or more processors individually or collectively, cause the electronic device to: select one of a transmission path based on a first radio access technology (RAT) and a transmission path based on a second RAT as a first transmission path, wherein the first transmission path is an uplink data transmission path to be used in the electronic device for a dual connectivity communication, perform, via the communication circuitry, an operation of stopping uplink data transmission and maintaining uplink control information transmission on a second transmission path other than the first transmission path among the transmission path based on the first RAT and the transmission path based on the second RAT, and perform, via the communication circuitry, an operation of transmitting at least one of uplink data or uplink control information on the first transmission path.

According to an aspect of the disclosure, a method performed by an electronic device, includes: selecting one of a transmission path based on a first radio access technology (RAT) and a transmission path based on a second RAT as a first transmission path, wherein the first transmission path is an uplink data transmission path to be used in the electronic device for a dual connectivity communication; performing an operation of stopping uplink data transmission and maintaining uplink control information transmission on a second transmission path other than the first transmission path among the transmission path based on the first RAT and the transmission path based on the second RAT; and performing an operation of transmitting at least one of uplink data or uplink control information on the first transmission path.

According to an aspect of the disclosure, an electronic device includes: communication circuitry; one or more processors; and memory storing instructions that, when executed by the one or more processors individually or collectively, cause the electronic device to, based on a designated condition being satisfied: select one of a transmission path based on a first radio access technology (RAT) and a transmission path based on a second RAT as a first transmission path, wherein the first transmission path is an uplink data transmission path to be used in the electronic device for a dual connectivity communication, perform, via the communication circuitry, an operation of stopping uplink data transmission and maintaining uplink control information transmission on a second transmission path other than the first transmission path among the transmission path based on the first RAT and the transmission path based on the second RAT, and perform, via the communication circuitry, an operation of transmitting at least one of uplink data or uplink control information on the first transmission path, based on the designated condition being unsatisfied: based on an amount of the uplink data, transmit the uplink data by using the transmission path based on the first RAT and the transmission path based on the second RAT, or by using a primary path among the transmission path based on the first RAT and the transmission path based on the second RAT.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment;

FIG. 2A is a block diagram illustrating an electronic device for supporting a legacy network communication and a 5^{th} generation (5G) network communication, according to an embodiment;

FIG. 2B is a block diagram illustrating an electronic device for supporting a legacy network communication and a 5G network communication, according to an embodiment;

FIG. 3 is a diagram illustrating a wireless communication system which provides a legacy network and/or a 5G network, according to an embodiment;

FIG. 4A is a diagram illustrating a protocol architecture per bearer type in an electronic device, according to an embodiment;

FIG. 4B is a diagram illustrating a protocol architecture per bearer type in a master node (MN) and a secondary node (SN), according to an embodiment;

FIG. 5 is a diagram illustrating a transmitting operation of an electronic device according to a dynamic power sharing (DPS) scheme, according to an embodiment;

FIG. 6A is a flowchart illustrating an operating process of an electronic device, according to an embodiment;

FIG. 6B is a diagram illustrating a transmitting operation of an electronic device, according to an embodiment.

FIG. 7A is a diagram illustrating a message indicating setting of a biased mode, according to an embodiment;

FIG. 7B is a diagram illustrating a biased mode control message, according to an embodiment;

FIG. 8A is a diagram illustrating a message indicating setting of a biased mode, according to an embodiment;

FIG. 8B is a diagram illustrating a biased mode control message, according to an embodiment;

FIG. 9A is a diagram illustrating a message indicating setting of a biased mode, according to an embodiment;

FIG. 9B is a diagram illustrating a biased mode control message, according to an embodiment;

FIG. 10 is a flowchart illustrating an operating process of an electronic device, according to an embodiment;

FIG. 11 is a diagram illustrating a transmitting operation of an electronic device, according to an embodiment;

FIG. 12A is a diagram illustrating a transmitting operation of an electronic device, according to an embodiment;

FIG. 12B is a diagram illustrating a transmitting operation of an electronic device, according to an embodiment;

FIG. 13 is a diagram illustrating a transmitting operation of an electronic device, according to an embodiment.

FIG. 14A is a diagram illustrating a transmitting operation of an electronic device, according to an embodiment;

FIG. 14B is a diagram illustrating a transmitting operation of an electronic device, according to an embodiment; and

FIG. 15 is a diagram illustrating a transmitting operation of an electronic device, according to an embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Hereinafter, an electronic device will be described in an embodiment of the disclosure, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an embodiment of the disclosure, the electronic device may be a device having a communication function such as, for example, a mobile phone, a personal digital assistant (PDA), a smart phone, a wireless MODEM, and a notebook.

Alternatively, in specifically describing an embodiment of the disclosure, reference will be made to long-term evolution (LTE) and NR (new radio) standards defined by the 3rd generation partnership project (3GPP) TS38.213 V16.8.0, 3GPP TS38.300 V16.8.0, 3GPP TS38.321 V16.7.0, 3GPP TS38.322 V16.2.0, 3GPP TS38.323 V16.6.0, and 3GPP TS38.331 V16.7.0, but the gist of the disclosure may be applied to other communication systems having similar technical backgrounds with some modifications without departing from the scope of the disclosure, which may be determined by those skilled in the technical field of the disclosure.

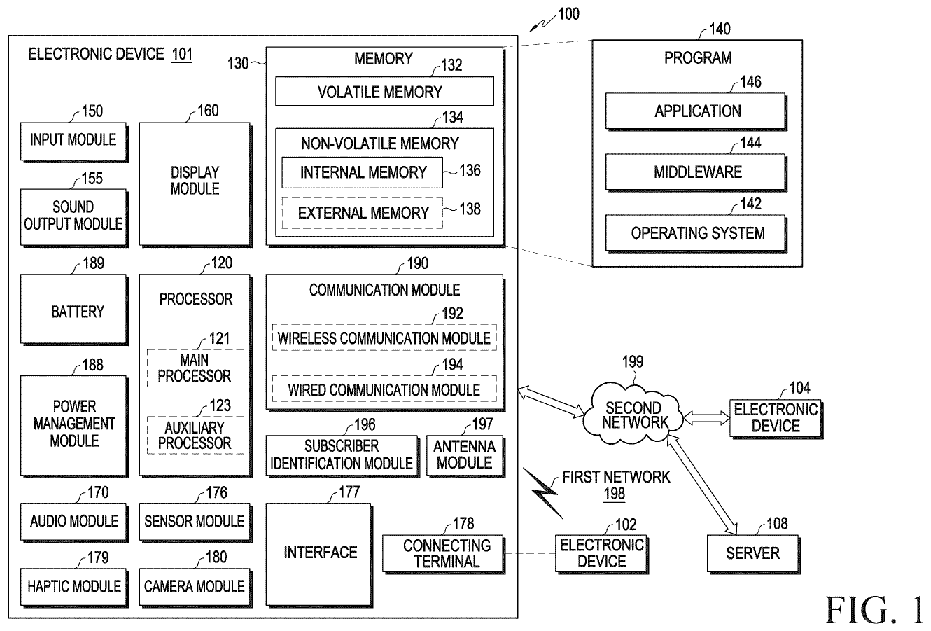

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to an embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

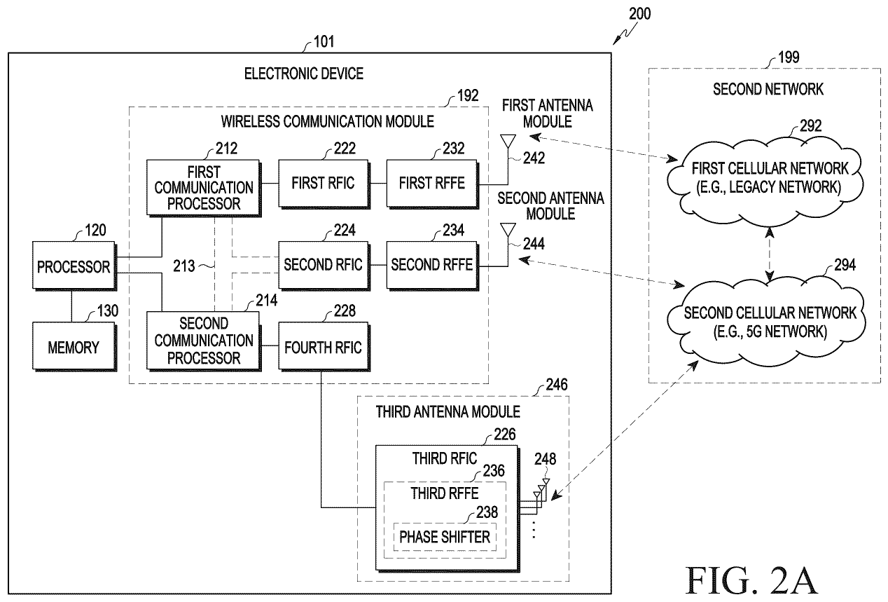

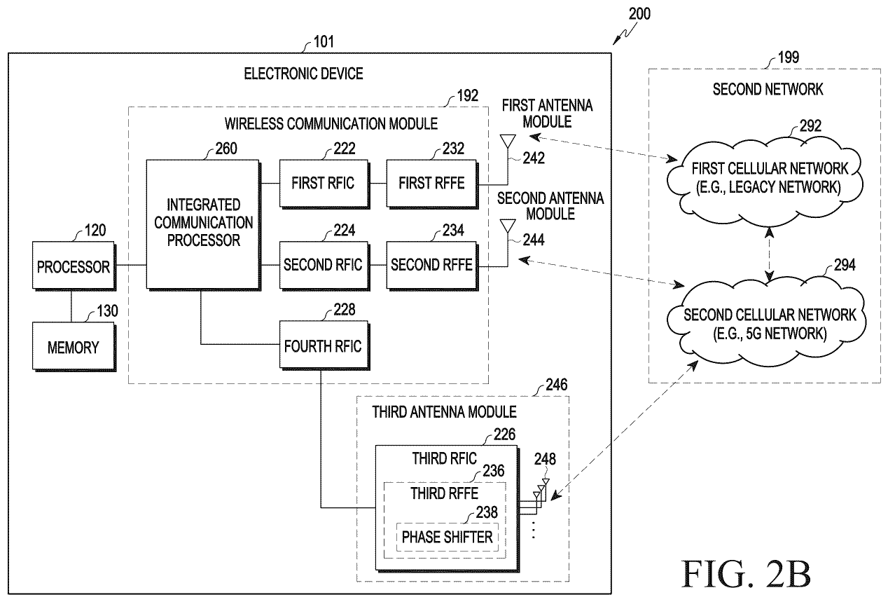

FIG. 2A is a block diagram 200 illustrating an electronic device for supporting a legacy network communication and a 5^{th} generation (5G) network communication according to an embodiment.

Referring to FIG. 2A, an electronic device 101 (e.g., an electronic device 101 in FIG. 1) may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 244, and/or antennas 248. The electronic device 101 may further include a processor 120 and a memory 130. A second network 199 may include a first cellular network 292 and a second cellular network 294.

In an embodiment, the electronic device 101 may further include at least one of the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and/or the second RFFE 234 may form at least part of a wireless communication module 192. In an embodiment, the fourth RFIC 228 may be omitted or included as part of the third RFIC 226.

The first communication processor 212 may establish a communication channel in a band to be used for a wireless communication with the first cellular network 292 and support a legacy network communication via the established communication channel. In an embodiment, the first cellular network 292 may be a legacy network including a 2^{nd} generation (2G) network, a 3^{rd} generation (3G) network, and/or a 4^{th} generation (4G) network (e.g., a long term evolution (LTE) network). The second communication processor 214 may establish a communication channel corresponding to a specified band (e.g., about 6 GHz to about 60 GHz) out of a band to be used for a wireless communication with the second cellular network 294 and support a 5G network communication via the established communication channel. In an embodiment, the second cellular network 294 may be a 5G network (e.g., a new radio (NR) network) defined by 3GPP. According to an embodiment, the first communication processor 212 or the second communication processor 214 may establish a communication channel corresponding to another specified band (e.g., about 6 GHz or less) out of the band to be used for the wireless communication with the second cellular network 294 and support a 5G network communication via the established communication channel.

The first communication processor 212 may transmit and receive data to and from the second communication processor 214. For example, data supposed to be transmitted via the second cellular network 294 may be scheduled to be transmitted via the first cellular network 292. In this case, the first communication processor 212 may receive transmission data from the second communication processor 214. For example, the first communication processor 212 may exchange data with the second communication processor 214 via an inter-processor interface 213. For example, the inter-processor interface 213 may be implemented as a universal asynchronous receiver/transmitter (UART) (e.g., high speed-UART (HS-UART)) interface or a peripheral component interconnect bus express (PCIe) interface, but a type thereof is not limited. For example, the first communication processor 212 and the second communication processor 214 may exchange control information and packet data information by using a shared memory. The first communication processor 212 may transmit and receive various pieces of information such as sensing information, information about output strength, and/or resource block (RB) allocation information to and from the second communication processor 214.

According to an implementation, the first communication processor 212 may not be coupled directly to the second communication processor 214. In this case, the first communication processor 212 may exchange data with the second communication processor 214 via the processor 120 (e.g., an application processor). For F example, the first communication processor 212 and the second communication processor 214 may transmit and receive data to and from the processor 120 via an HS-UART interface or a PCIe interface, but a type of an interface is not limited. In an embodiment, the first communication processor 212 and the second communication processor 214 may exchange control information and packet data information by using, for example, the processor 120 and the shared memory.

According to an embodiment, the first communication processor 212 and the second communication processor 214 may be incorporated in a single chip or a single package. In an embodiment, the first communication processor 212 or the second communication processor 214 may be incorporated together with the processor 120 (e.g., a main processor 121 and an auxiliary processor 123 in FIG. 1), or a wireless communication module 192 (e.g., a communication module 190 in FIG. 1) in a single chip or a single package.

For transmission, the first RFIC 222 may convert a baseband signal generated by the first communication processor 212 to a radio frequency (RF) signal in about 700 MHz to about 3 GHz used in the first cellular network 292 (e.g., the legacy network). For reception, an RF signal may be obtained from the first cellular network 292 (e.g., the legacy network) via an antenna (e.g., the first antenna module 242) and pre-processed via an RFFE (e.g., the first RFFE 232). The first RFIC 222 may convert the pre-processed RF signal to a baseband signal so that the baseband signal may be processed by the first communication processor 212.

For transmission, the second RFIC 224 may convert a baseband signal generated by the first communication processor 212 or the second communication processor 214 to an RF signal in a Sub6 band (e.g., about 6 GHz or less) used in the second cellular network 294 (e.g., the 5G network). For reception, a 5G Sub6 RF signal may be obtained from the second cellular network 294 (e.g., the 5G network) via an antenna (e.g., the second antenna module 244) and pre-processed in an RFFE (e.g., the second RFFE 234). The second RFIC 224 may convert the pre-processed 5G Sub6 RF signal to a baseband signal so that the baseband signal may be processed by a corresponding one between the first communication processor 212 and the second communication processor 214.

For transmission, the third RFIC 226 may convert a baseband signal generated by the second communication processor 214 to an RF signal (hereinafter, referred to as, a 5G Above6 RF signal) in a 5G Above6 band (e.g., about 6 GHz to about 60 GHz) to be used in the second cellular network 294 (e.g., the 5G network). For reception, a 5G Above6 RF signal may be obtained from the second cellular network 294 (e.g., the 5G network) via an antenna (e.g., the antenna 248) and pre-processed via the third RFFE 236. The third RFIC 226 may convert the pre-processed 5G Above6 RF signal to a baseband signal so that the baseband signal may be processed by the second communication processor 214. According to an embodiment, the third RFFE 236 may be formed as part of the third RFIC 226.

In an embodiment, the electronic device 101 may include the fourth RFIC 228 separately from or as part of the third RFIC 226. In this case, the fourth RFIC 228 may convert a baseband signal generated by the second communication processor 214 to an RF signal in an intermediate frequency (IF) band (e.g., about 9 GHz to about 11 GHz) (hereinafter, referred to as an IF signal), and provide the IF signal to the third RFIC 226. The third RFIC 226 may convert the IF signal to a 5G Above6 RF signal. During reception, a 5G Above6 RF signal may be received from the second cellular network 294 (e.g., the 5G network) through an antenna (e.g., the antenna 248) and converted to an IF signal by the third RFIC 226. The fourth RFIC 228 may convert the IF signal to a baseband signal so that the baseband signal may be processed by the second communication processor 214.

According to an embodiment, the first RFIC 222 and the second RFIC 224 may be implemented as at least part of a single chip or a single package. In an embodiment, if the first RFIC 222 and the second RFIC 224 are implemented as a single chip or a single package in FIG. 2A, the first RFIC 222 and the second RFIC 224 may be implemented as an integrated RFIC. In this case, the integrated RFIC is connected to the first RFFE 232 and the second RFFE 234, so the integrated RFIC may convert a baseband signal into a signal of a band supported by the first RFFE 232 and/or the second RFFE 234, and transfer the converted signal to one of the first RFFE 232 and the second RFFE 234. According to an embodiment, the first RFFE 232 and the second RFFE 234 may be implemented as at least part of a single chip or a single package. According to an embodiment, at least one antenna module of the first antenna module 242 or the second antenna module 244 may be omitted or combined with the other antenna module to process RF signals in a plurality of corresponding bands.

According to an embodiment, the third RFIC 226 and the antenna 248 may be arranged on the same substrate to form a third antenna module 246. For example, the wireless communication module 192 or the processor 120 may be arranged on a first substrate (e.g., a main PCB). In this case, the third RFIC 226 may be arranged in a partial area (e.g., the bottom surface) of a second substrate (e.g., a sub PCB) other than the first substrate and the antenna 248 may be arranged in another partial area (e.g., the top surface) of the second substrate, to form the third antenna module 246. As the third RFIC 226 and the antenna 248 are arranged on the same substrate, it is possible to reduce length of a transmission line between the third RFIC 226 and the antenna 248. By reducing the length of the transmission line between the third RFIC 226 and the antenna 248, the amount of loss (e.g., attenuation) of a signal in a high frequency band (e.g., about 6 GHz to about 60 GHz) used for a 5G network communication by the transmission line. Therefore, the electronic device 101 may increase quality or a speed of a communication with the second cellular network 294 (e.g., the 5G network).

According to an embodiment, the antenna 248 may be formed as an antenna array including a plurality of antenna elements which may be used for beamforming. In this case, the third RFIC 226 may include a plurality of phase shifters 238 corresponding to the plurality of antenna elements, as part of the third RFFE 236. During transmission, each of the plurality of phase shifters 238 may change a phase of a 5G Above6 RF signal to be transmitted to the outside of the electronic device 101 (e.g., a base station (e.g., a gNB) in the 5G network) via a corresponding antenna element. During reception, each of the phase shifters 238 may change a phase of a 5G Above6 RF signal received from the outside of the electronic device 101 via a corresponding antenna element to the same or substantially same phase. This enables transmission or reception via beamforming between the electronic device 101 and the outside of the electronic device 101.

The second cellular network 294 (e.g., the 5G network) may be operated independently of the first cellular network 292 (e.g., the legacy network) (e.g., standalone (SA) structure) or in connection to the first cellular network 292 (e.g., non-standalone (NSA) structure). For example, in the 5G network, only an access network (e.g., a 5G radio access network (RAN) or next generation RAN (NG RAN)) may exist, and a core network (e.g., a next generation core (NGC)) may not exist. In this case, after accessing the access network of the 5G network, the electronic device 101 may access an external network (e.g., an Internet) under the control of a core network (e.g., an evolved packet core (EPC)) of the legacy network. Protocol information for a communication with the legacy network (e.g., LTE protocol information) and protocol information for a communication with the 5G network (e.g., NR protocol information) may be stored in the memory 230 and accessed by another component (e.g., the processor 120, the first communication processor 212, or the second communication processor 214).

FIG. 2B is a block diagram 250 illustrating an electronic device for supporting a legacy network communication and a 5G network communication according to an embodiment.

Referring to FIG. 2B, an electronic device 101 (e.g., an electronic device 101 in FIG. 1) may include an integrated communication processor 260, a first RFIC 222, a second RFIC 224, a third RFIC 226, a fourth RFIC 228, a first RFFE 232, a second RFFE 234, a first antenna module 242, a second antenna module 244, a third antenna module 246, and/or antennas 248. The electronic device 101 may further include a processor 120 and a memory 130. A second network 199 may include a first cellular network 292 and a second cellular network 294.

In the block diagram 250 of the electronic device 101 shown in FIG. 2B comparing to the block diagram 200 of the electronic device 101 shown in FIG. 2A, it differs only in that the first communication processor 212 and the second communication processor 214 are implemented as the integrated communication processor 260, and the remaining components included in the block diagram 250 of the electronic device 101 may be implemented similarly or substantially the same as the components included in the block diagram 200 of the electronic device 101 shown in FIG. 2A, so a detailed description thereof will be omitted.

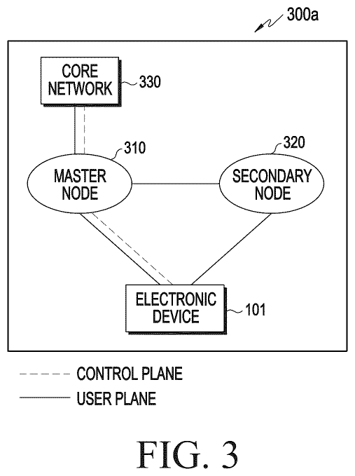

FIG. 3 is a diagram illustrating a wireless communication system providing a legacy network and/or a 5G network, according to an embodiment.

Referring to FIG. 3, a network environment 300a may include at least one of a legacy network or a 5G network. For example, the legacy network may include a 4G (e.g., LTE) base station (e.g., an eNodeB (eNB)) of the 3GPP standard supporting a wireless access of an electronic device 101 (e.g., an electronic device 101 in FIGS. 1, 2A, or 2B), and an EPC which manages a 4G communication. For example, the 5G network may include an NR base station (e.g., a gNB) supporting a wireless access of the electronic device 101, and a 5GC which manages a 5G communication of the electronic device 101.

According to an embodiment, the electronic device 101 may transmit and receive control information (e.g., a control message) and data (e.g., user data) via a legacy communication and/or 5G communication. For example, the control message may include a message related to at least one of security control, bearer establishment, authentication, registration, or mobility management of the electronic device 101. For example, the user data may mean data except for a control message transmitted and received between the electronic device 101 and a core network 330 (e.g., the EPC).

Referring to FIG. 3, the electronic device 101 according to an embodiment may transmit and receive at least one of a control message or user data to and from at least part (e.g., an NR base station and/or a 5GC) of the 5G network using at least part (e.g., an LTE base station and/or an EPC) of the legacy network.

According to an embodiment, the network environment 300a may include a network environment which provides dual connectivity to the LTE base station and the NR base station and transmits and receives a control message to and from the electronic device 101 via one core network 330 of the EPC or the 5GC.

According to an embodiment, in a dual connectivity environment, one of the LTE base station (e.g., an eNB) and the NR base station (e.g., a gNB) may operate as a master node (MN) 310 and the other may operate as a secondary node (SN) 320. The MN 310 may be connected to the core network 330 and transmit and receive a control message to and from the core network 330. The MN 310 and the SN 320 may be connected to each other via a network interface and transmit and receive a message related to management of a radio resource (e.g., a communication channel) to and from each other.

According to an embodiment, the MN 310 may be implemented with the LTE base station, the SN 320 may be implemented with the NR base station, and the core network 330 may include the EPC. For example, a control message may be transmitted and received via the LTE base station and the EPC, and user data may be transmitted via at least one of the LTE base station or the NR base station.

According to an embodiment, the MN 310 may consist of the NR base station, the SN 320 may consist of the LTE base station, and the core network 330 may include the 5GC. For example, a control message may be transmitted and received via the NR base station and the 5GC, and user data may be transmitted via at least one of the LTE base station or the NR base station.

According to an embodiment, the electronic device 101 may be registered in at least one of the EPC or the 5GC, and transmit and receive a control message.

According to an embodiment, the EPC and the 5GC may interwork together and may manage a communication of the electronic device 101. For example, mobility information of the electronic device 101 may be transmitted and received via an interface between the EPC and the 5GC.

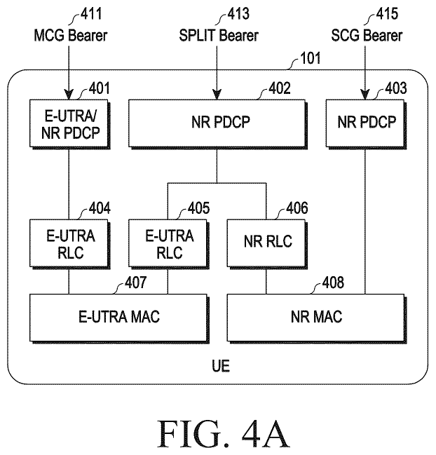

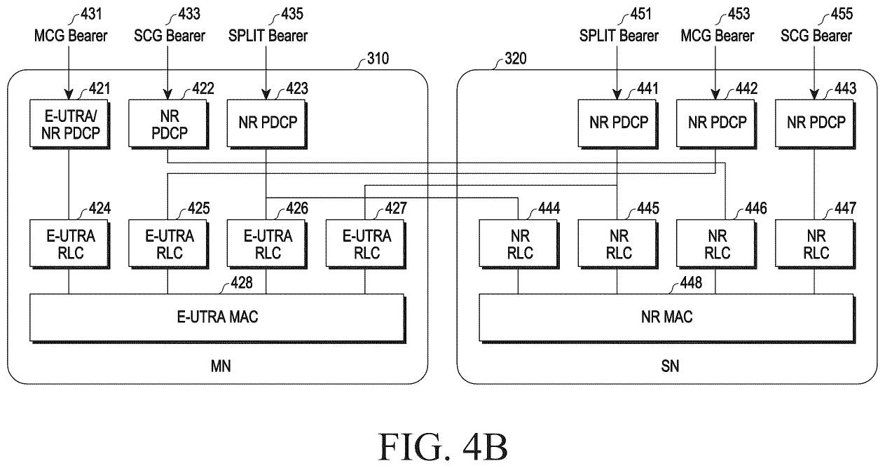

FIG. 4A is a diagram illustrating a protocol architecture per bearer type in an electronic device, according to an embodiment.

FIG. 4B is a diagram illustrating a protocol architecture per bearer type in an MN and an SN, according to an embodiment.

Referring to FIGS. 4A and 4B, a 5G system based on a 5G mobile communication standard (e.g., an NR standard) proposed by a 3GPP may interwork with a 4G system based on a 4G mobile communication standard (e.g., an LTE standard). The 5G system may support an SA structure in which the 5G system operates alone, and an NSA structure in which the 5G system interworks with the 4G system. The NSA structure supports an E-UTRA NR dual connectivity (EN-DC) scheme. For example, in the EN-DC scheme, the 4G system may be used as a primary system and the 5G system may be used as a secondary system.

In the EN-DC scheme, a bearer structure for a transmission path for a communication between an electronic device (e.g., a user equipment (UE)) 101 (e.g., an electronic device 101 in FIG. 1, 2A, 2B, or 3) and a network may have various bearer types and protocol architectures according to a transmission path, a protocol type of a packet data convergence protocol (PDCP) entity, and/or a location of a PDCP protocol stack. In the EN-DC scheme, a master cell group (MCG) bearer, a secondary cell group (SCG) bearer, and/or a split bearer may be supported. For example, an MCG may correspond to MN a 310 (e.g., an MN 310 in FIG. 3), and an SCG may correspond to an SN 320 (e.g., an SN 320 in FIG. 3).

The MCG bearer may be a bearer associated with a transmission path (e.g., an LTE transmission path) to the 4G system. In the MCG bearer, entities (e.g., a radio link control (RLC) entity, a medium access control (MAC) entity, and/or a physical (PHY) entity) other than the PDCP entity which may use both the 4G standard and the 5G standard may use a 4G protocol stack based on the 4G standard.

The SCG bearer may be a bearer associated with a transmission path (e.g., an NR transmission path) to the 5G system. In the SCG bearer, the PDCP entity, the RLC entity, the MAC entity, and/or the PHY entity may use a 5G protocol stack based on the 5G standard.

The split bearer may be a bearer associated with the transmission path to the 4G system and the transmission path to the 5G system. In the split bearer, the PDCP entity, the RLC entity, the MAC entity, and/or the PHY entity may use the 4G protocol stack and the 5G protocol stack. In the split bearer, the transmission path to the 4G system and the transmission path to the 5G system may be used simultaneously, so a data rate may be increased.

In a protocol stack of the electronic device 101 according to an embodiment, operations for processing a communication protocol among an RRC layer, a PDCP layer, an RLC layer, a MAC layer, and a PHY layer may be performed by an RRC entity, a PDCP entity, an RLC entity, a MAC entity, and a PHY entity which are logical entities responsible for each layer. In an embodiment, a program which defines an operation of each of the RRC entity, the PDCP entity, the RLC entity, the MAC entity, and the PHY entity based on a communication protocol may be included (for example, may be stored) in the electronic device 101. In the electronic device 101, at least one processor may control operations among the RRC entity, the PDCP entity, the RLC entity, the MAC entity, and the PHY entity according to an embodiment based on the program. In an embodiment, the at least one processor may include a communication processor (e.g., a processor 120 in FIG. 1, a first communication processor 212 or a second communication processor 214 in FIG. 2A, or a communication processor 260 in FIG. 2B).

In an embodiment, the protocol stack of the electronic device 101 may include an E-UTRA/NR PDCP entity 401, an NR PDCP entity 402, an NR PDCP entity 403, an E-UTRA RLC entity 404, an E-UTRA RLC entity 405, an NR RLC entity 406, an E-UTRA MAC entity 407, and/or an NR MAC entity 408. The E-UTRA/NR PDCP entity 401, the E-UTRA RLC entity 404, and/or the E-UTRA MAC entity 407 may be associated with an MCG bearer 411. The NR PDCP entity 402, the E-UTRA RLC entity 405, the NR RLC entity 406, the E-UTRA MAC entity 407, and/or the NR MAC entity 408 may be associated with a split bearer 413. The NR PDCP entity 403 and/or the NR MAC entity 408 may be associated with the SCG bearer 415.

In an embodiment, a protocol stack of the MN 310 may include an E-UTRA/NR PDCP entity 421, an NR PDCP entity 422, an NR PDCP entity 423, an E-UTRA RLC entity 424, an E-UTRA RLC entity 425, an E-UTRA RLC entity 426, an E-UTRA RLC entity 427, and/or an E-UTRA MAC entity 428. In an embodiment, a protocol stack of the SN 310 may include an NR PDCP entity 441, an NR PDCP entity 442, an NR PDCP entity 443, an NR RLC entity 444, an NR RLC entity 445, an NR RLC entity 446, an NR RLC entity 447, and/or an NR MAC entity 448.

In an embodiment, the E-UTRA/NR PDCP entity 421, the E-UTRA RLC entity 424, and/or the E-UTRA MAC entity 428 may be associated with an MCG bearer 431. The NR PDCP entity 422, the NR RLC entity 446, and/or the NR MAC entity 448 may be associated with an SCG bearer 433. The NR PDCP entity 423, the E-UTRA RLC entity 427, the E-UTRA MAC entity 428, the NR RLC entity 444, and/or the NR MAC entity 448 may be associated with a split bearer 435.

In an embodiment, the NR PDCP entity 441, the NR RLC entity 445, the NR MAC entity 448, the E-UTRA RLC entity 427, and/or the E-UTRA MAC entity 428 may be associated with a split bearer 451. The NR PDCP entity 442, the E-UTRA RLC entity 425, and/or the E-UTRA MAC entity 428 may be associated with an MCG bearer 453. The NR PDCP entity 443, an NR RLC entity 447, and/or an NR MAC entity 448 may be associated with an SCG bearer 455.

In an embodiment, each of the PDCP entities 401, 402, 403, 421, 422, 423, 441, 442, and 443 may receive data (e.g., a PDCP service data unit (SDU) corresponding to an IP packet) to output converted data (e.g., a PDCP protocol data unit (PDU)) in which additional information (e.g., header information) is reflected. Each of the RLC entities 404, 405, 406, 424, 425, 426, 427, 444, 445, 446, and 447 may receive converted data (e.g., a PDCP PDU) outputted from a corresponding PDCP entity to output converted data (e.g., an RLC PDU) in which additional information (e.g., header information) is reflected. Each of the MAC entities 407, 408, 428, and 448 may receive converted data (e.g., an RLC PDU) outputted from a corresponding RLC entity to output, to a corresponding PHY entity, converted data (e.g., a MAC PDU) in which additional information (e.g., header information) is reflected.

In a dual connectivity scheme, the MCG bearers 411, 431, and 451 may be associated with a path which may transmit and receive data using resources or entities corresponding to the MN 310. In the dual connectivity scheme, the SCG bearers 415, 433, and 455 may be associated with a path which may transmit and receive data using resources or entities corresponding to the SN 320. In the dual connectivity scheme, the split bearers 413, 435, and 451 may be associated with a path which may transmit and receive data by using the resources or the entities corresponding to the MN 310 or the resources or the entities corresponding to the SN 320.

In an embodiment, an operation in which the electronic device 101 transmits uplink data through each transmission path of the split bearer 413 will be described as follows.

First, the NR PDCP entity 402 may identify whether a sum of data volume of the NR PDCP entity 402 and data volume of RLC entities (e.g., the E-UTRA RLC entity 405 and the NR RLC entity 406) associated with two transmission paths (e.g., an LTE transmission path and an NR transmission path) is greater than or equal to ul-DataSplitThreshold which is set threshold data volume. In an embodiment, ul-DataSplitThreshold may be provided to the electronic device 101 through a higher layer (or a higher entity) (e.g., a radio resource control (RRC) entity) signaling. In an embodiment, ul-DataSplitThreshold may be provided to the electronic device 101 through an RRC Reconfiguration message. If a split bearer is configured for the electronic device 101, a value of ul-DataSplitThreshold may be set to a first value, and if the split bearer is not configured for the electronic device 101, the value of ul-DataSplitThreshold may be set to a second value (e.g., infinity).

As a result of the identification, if the sum of the data volume of the NR PDCP entity 402, the data volume of the E-UTRA RLC entity 405, and the data volume of the NR RLC entity 406 is greater than or equal to ul-DataSplitThreshold, the NR PDCP entity 402 may distribute (or submit) a PDCP PDU, which is data of the NR PDCP entity 402, to an RLC entity (e.g., the E-UTRA RLC entity 405) associated with a primary path or an RLC entity (e.g., the NR RLC entity 406) associated with a secondary path. As a result of the identification, if the sum of the data volume of the NR PDCP entity 402, the data volume of the E-UTRA RLC entity 405, and the data volume of the NR RLC entity 406 is less than ul-DataSplitThreshold, the NR PDCP entity 402 may distribute the PDCP PDU only to an RLC entity related to the primary path.

The data distributed from the NR PDCP entity 402 through the primary path and/or the secondary path may be transmitted through an air channel (e.g., a PHY entity) associated with each transmission path through a corresponding RLC entity and MAC entity.

In order to be allocated a PHY channel for a transmitting operation in a PHY entity associated with each transmission path, the MAC entities 407 and 408 may perform a buffer status report (BSR) operation for transmitting a BSR for informing a serving base station of data volume of uplink data to be transmitted. A BSR operation according to an embodiment will be described as follows.

The BSR operation may be used for providing the serving base station with information about data volume of uplink data of the MAC entities 407 and 408. The MAC entities 407 and 408 may identify data volume of the RLC entities 405 and 406 and the NR PDCP entity 402 based on ul-DataSplitThreshold. In an embodiment, if the sum of the data volume of the NR PDCP entity 402, the data volume of the E-UTRA RLC entity 405, and the data volume of the NR RLC entity 406 is greater than or equal to ul-DataSplitThreshold, the NR PDCP entity 402 may transfer information about the data volume of the NR PDCP entity 402 to both a MAC entity (e.g., the E-UTRA MAC entity 407) associated with the primary path and a MAC entity (e.g., the NR MAC entity 408) associated with the secondary path. In an embodiment, if the sum of the data volume of the NR PDCP entity 402, the data volume of the E-UTRA RLC entity 405, and the data volume of the NR RLC entity 406 is less than ul-DataSplitThreshold, the NR PDCP entity 402 may transfer the information about the data volume of the NR PDCP entity 402 to the MAC entity (e.g., the E-UTRA MAC entity 407) associated with the primary path.

In an embodiment, an RLC entity (e.g., the E-UTRA RLC entity 405) associated with the primary path may transfer information about data volume of the RLC entity associated with the primary path to a MAC entity (e.g., the E-UTRA MAC entity 407) associated with the primary path, and an RLC entity (e.g., the NR RLC entity 406) associated with the secondary path may transfer information about data volume of the RLC entity associated with the secondary path to an associated MAC entity (e.g., the NR MAC entity 408) on the secondary path.

In an embodiment, the MAC entity (e.g., the E-UTRA MAC entity 407) associated with the primary path may transmit a BSR to a base station based on the information about the data volume of the NR PDCP entity 402 received from the NR PDCP entity 402 and the information about the data volume of the RLC entity (e.g., the E-UTRA RLC entity 405) associated with the primary path.

In an embodiment, the MAC entity (e.g., the NR MAC entity 408) associated with the secondary path may transmit a BSR to the base station based on the information about the data volume of the NR PDCP entity 402 received from the NR PDCP entity 402 and the information about the data volume of the RLC entity (e.g., the NR RLC entity 406) associated with the secondary path.

In an embodiment, if the sum of the data volume of the NR PDCP entity 402, the data volume of the E-UTRA RLC entity 405, and the data volume of the NR RLC entity 406 is greater than or equal to ul-DataSplitThreshold, the MAC entity (e.g., the E-UTRA MAC entity 407) associated with the primary path may perform a BSR operation based on the data volume of the NR PDCP entity 402 and the data volume of the RLC entity (e.g., the E-UTRA RLC entity 405) associated with the primary path, and the MAC entity (e.g., the NR MAC entity 408) associated with the secondary path may perform a BSR operation based on the data volume of the PDCP entity 402 and the data volume of the RLC entity (e.g., the NR RLC entity 406) associated with the secondary path.

As such, for a BSR operation proposed in a current 3GPP NR standard, data volume of a PDCP entity has been considered in both a MAC entity associated with a primary path and a MAC entity associated with a secondary path, so the data volume of the PDCP entity has been considered redundant in the BSR operation. As such, if the data volume of the PDCP entity is considered in both the MAC entity associated with the primary path and the MAC entity associated with the secondary path, uplink radio resources exceeding uplink radio resources required for actual transmission on an uplink split bearer may be allocated for uplink transmission. Allocation of unnecessary uplink radio resources other than the uplink radio resources required for the actual uplink transmission may cause unnecessary uplink transmission such as padding data transmission, and such unnecessary uplink transmission may cause waste of transmission power and may also increase signaling overhead of the overall system.

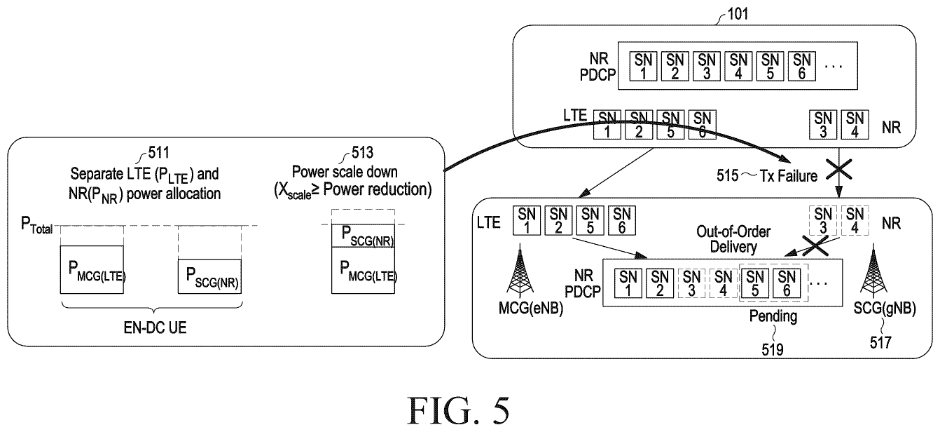

According to an embodiment, for an uplink split bearer, a dynamic power sharing (DPS) scheme may be used for efficiently managing transmission power for a primary path and transmission power for a secondary path, and the DPS scheme will be described with reference to FIG. 5.

FIG. 5 is a diagram illustrating a transmitting operation of an electronic device according to a DPS scheme, according to an embodiment.

Referring to FIG. 5, in a DPS scheme, transmission power for a primary path (e.g., an MCG) may be basically allocated preferentially, and transmission power for a secondary path (e.g., an SCG) may be allocated within transmission power excluding the transmission power allocated for the primary path among the total transmission power (operation 511). In FIG. 5, it may be assumed that the primary path is a path (e.g., an LTE transmission path) to a 4G network, and the secondary path is a path (e.g., an NR transmission path) to a 5G network. In FIG. 5, P_{MCG(LTE)} may represent transmission power allocated for the LTE transmission path, and P_{SCG(NR)} may represent transmission power allocated for the NR transmission path.

The transmission power allocated for the NR transmission path may be limited according to the transmission power allocated for the LTE transmission path, so smaller transmission power may be allocated for the NR transmission path compared to transmission power actually required for the NR transmission path. In this case, a power scale down operation may be performed according to the overall transmission power limit based on dual connectivity (operation 513). In an embodiment, if a difference between the transmission power actually required for the NR transmission path and the transmission power allocated for the NR transmission path is less than or equal to xScale, which is a set threshold transmission power, the power scale down operation may be performed.

Based on the power scale down operation, if the difference between the transmission power actually required for the NR transmission path and the transmission power allocated for the NR transmission path is less than or equal to xScale, an electronic device (e.g., an EN-DC UE) 101 (e.g., an electronic device 101 in FIG. 1, 2A, 2B, or 3) may perform a transmitting operation with the transmission power allocated for the NR transmission path which is less than the transmission power actually required for the NR transmission path. The EN-DC UE may represent a UE which supports an EN-DC scheme. In an embodiment, xScale may be provided to the electronic device 101 through a higher layer (or higher entity) (e.g., RRC entity) signaling (e.g., an RRC message). In an embodiment, xScale may be provided to the electronic device 101 through an RRC reconfiguration message.

If the transmitting operation is performed with the transmission power smaller than the transmission power actually required for the NR transmission path according to the power scale down operation, transmission failure 515 may occur repeatedly. The repeated transmission failures 515 may cause repetitive retransmitting operations, and the repetitive retransmitting operations may not only cause waste of transmission power, but also cause a pending phenomenon 519 in which a receiving device (e.g., a gNB 517) waits for reception of corresponding data.

Accordingly, an embodiment may provide an electronic device for controlling transmission paths based on transmission power in an uplink split bearer environment to prevent unnecessary waste of transmission power and an operating method (a method) thereof.

An embodiment of the disclosure may provide an electronic device for supporting dual connectivity and an operating method thereof.

An embodiment of the disclosure may provide an electronic device for controlling transmission paths in an uplink split bearer environment and an operating method thereof.

An embodiment of the disclosure may provide an electronic device for controlling transmission paths based on transmission power in an uplink split bearer environment and an operating method thereof.

An embodiment of the disclosure may provide an electronic device for stopping uplink data transmission through a specific transmission path in an uplink split bearer environment and an operating method thereof.

According to an embodiment of the disclosure, an electronic device (e.g., an electronic device 101 in FIG. 1, 2A, 2B, or 6B) may be provided, and the electronic device (e.g., the electronic device 101 in FIG. 1, 2A, 2B, or 6B) may include communication circuitry (e.g., a communication module 190 in FIG. 1, or a first RFIC 222, a second RFIC 224, a third RFIC 226, a fourth RFIC 228, a second RFFE 232, a second RFFE 234, and a third RFFE 236 in FIG. 2A or 2B), one or more processors (e.g., a processor 120 in FIG. 1, a first communication processor 212 or a second communication processor 214 in FIG. 2A, or a communication processor 260 in FIG. 2B); and memory (memory 130 in FIG. 1) storing instructions.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to select one of a transmission path based on a first radio access technology (RAT) and a transmission path based on a second RAT as a first transmission path, which is an uplink data transmission path to be used in the electronic device (e.g., the electronic device 101 in FIG. 1, 2A, 2B, or 6B), for a dual connectivity communication.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), an operation of stopping uplink data transmission and maintaining uplink control information transmission on a second transmission path other than the first transmission path among the transmission path based on the first RAT and the transmission path based on the second RAT.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), an operation of transmitting at least one of uplink data or uplink control information on the first transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to cause a medium access control (MAC) entity associated with the second transmission path to generate a buffer status report (BSR) including information associated with amount of uplink data of a radio link control (RLC) entity associated with the second transmission path, from which amount of uplink data of a packet data convergence protocol (PDCP) entity associated with the first transmission path and the second transmission path is excluded.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to transmit, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), the generated BSR to a base station associated with the second RAT on the second transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to cause a physical (PHY) entity associated with the second transmission path to stop transmission of a transport block (TB) on a radio resource allocated from the base station related to the second RAT.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to cause a radio link control (RLC) entity associated with the second transmission path to transfer uplink data of the RLC entity to a packet data convergence protocol (PDCP) entity associated with the first transmission path and the second transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to receive, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), a radio resource control (RRC) message from at least one of a base station associated with the first RAT or the base station associated with the second RAT.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to identify whether a set condition is satisfied, based on the received RRC message.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to select the first transmission path, based on identifying that the set condition is satisfied.

According to an embodiment of the disclosure, the set condition may include at least one of a condition in which an uplink split bearer, which corresponds to the transmission path based on the first RAT and the transmission path based on the second RAT, is configured in the electronic device (e.g., the electronic device 101 in FIG. 1, 2A, 2B, or 6B), a condition in which at least one of uplink data transmission on the transmission path based on the first RAT or uplink data transmission on the transmission path based on the second RAT is supported to be stopped, a condition in which a difference between transmission power allocated to a primary path among the transmission path based on the first RAT and the transmission path based on the second RAT and transmission power allocated to a secondary path other than the primary path is less than or equal to a first threshold transmission power and is greater than or equal to a second threshold transmission power, a condition in which the difference between the transmission power allocated to the primary path and the transmission power allocated to the secondary path is greater than or equal to the first threshold transmission power, or a condition in which it is indicated to perform an operation of transmitting at least one of the uplink data or the uplink control information on the first transmission path, and stopping the uplink data transmission and maintaining the uplink control information transmission on the second first transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to identify whether a set condition is satisfied.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to select the first transmission path based on identifying that the set condition is satisfied.

According to an embodiment of the disclosure, the set condition may include at least one of a condition in which an error rate measured on at least one of the transmission path based on the first RAT and the transmission path based on the second RAT is greater than or equal to a threshold error rate, a condition in which a number of non-acknowledgements (NACKs), which are received on at least one of the transmission path based on the first RAT and the transmission path based on the second RAT during a set time period via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), is greater than or equal to a threshold number, or a condition in which a battery capacity is less than or equal to a threshold battery capacity.

According to an embodiment of the disclosure, the electronic device (e.g., the electronic device 101 in FIG. 1, 2A, 2B, or 6B) may further include a display module (e.g., a display module 160 in FIG. 1).

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to identify whether a set condition is satisfied.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to o select the first transmission path, based on identifying that the set condition is satisfied.

According to an embodiment of the disclosure, the set condition may include at least one of a condition for outputting, via the display module (e.g., the display module 160 in FIG. 1), a notification message notifying to perform an operation of transmitting at least one of the uplink data or the uplink control information on the first transmission path, and stopping the uplink data transmission and maintaining the uplink control information transmission on the second transmission path, or a condition for receiving, via the display module (e.g., the display module 160 in FIG. 1), an input requesting to perform an operation of transmitting at least one of the uplink data or the uplink control information on the first transmission path, and stopping the uplink data transmission and maintaining the uplink control information transmission on the second transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to adjust amount of uplink data for the first transmission path and amount of uplink data for the second transmission path corresponding to a set ratio.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), a transmitting operation on the first transmission path based on the adjusted amount of uplink data for the first transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), a transmitting operation on the second transmission path based on the adjusted amount of uplink data for the second transmission path.

According to an embodiment of the disclosure, an electronic device (e.g., an electronic device 101 in FIG. 1, 2A, 2B, or 6B) may be provided, and the electronic device (e.g., the electronic device 101 in FIG. 1, 2A, 2B, or 6B) may include communication circuitry (e.g., a communication module 190 in FIG. 1, or a first RFIC 222, a second RFIC 224, a third RFIC 226, a fourth RFIC 228, a second RFFE 232, a second RFFE 234, and a third RFFE 236 in FIG. 2A or 2B), one or more processors (e.g., a processor 120 in FIG. 1, a first communication processor 212 or a second communication processor 214 in FIG. 2A, or a communication processor 260 in FIG. 2B); and memory (memory 130 in FIG. 1) storing instructions.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to, based on a designated condition being satisfied, select one of a transmission path based on a first radio access technology (RAT) and a transmission path based on a second RAT as a first transmission path, which is an uplink data transmission path to be used in the electronic device (e.g., the electronic device 101 in FIG. 1, 2A, 2B, or 6B), for a dual connectivity communication.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), an operation of stopping uplink data transmission and maintaining uplink control information transmission on a second transmission path other than the first transmission path among the transmission path based on the first RAT and the transmission path based on the second RAT.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to perform, via the communication circuitry (e.g., the communication module 190 in FIG. 1, or the first RFIC 222, the second RFIC 224, the third RFIC 226, the fourth RFIC 228, the second RFFE 232, the second RFFE 234, and the third RFFE 236 in FIG. 2A or 2B), an operation of transmitting at least one of uplink data or uplink control information on the first transmission path.

According to an embodiment of the disclosure, the instructions, when executed by the one or more processors (e.g., the processor 120 in FIG. 1, the first communication processor 212 or the second communication processor 214 in FIG. 2A, or the communication processor 260 in FIG. 2B) individually or collectively, cause the electronic device (e.g., the electronic device 101 in FIG. 1, 2A, 2B, or 6B) to, based on a designated condition being unsatisfied, based on amount of the uplink data, transmit the uplink data by using the transmission path based on the first RAT and the transmission path based on the second RAT, or by using a primary path among the transmission path based on the first RAT and the transmission path based on the second RAT.

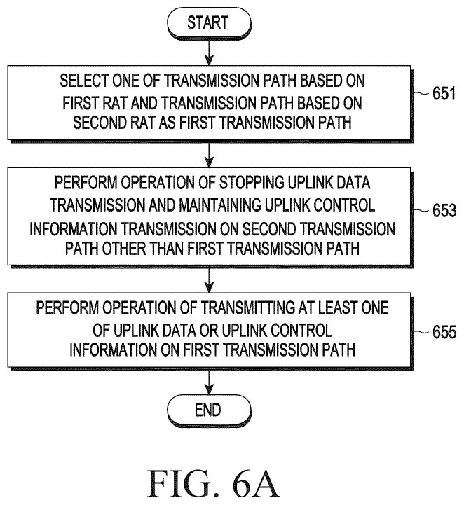

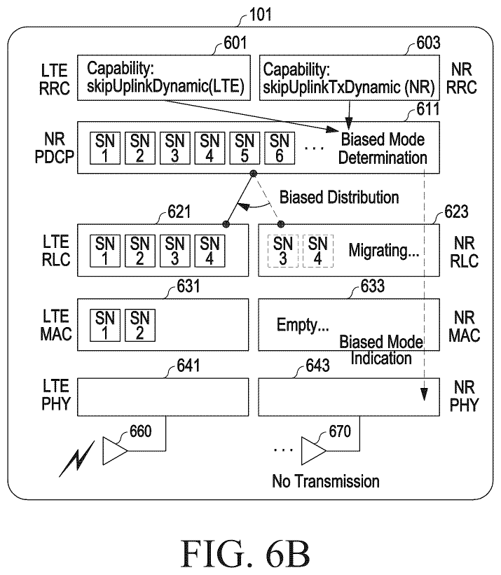

FIG. 6A is a flowchart illustrating an operating process of an electronic device, according to an embodiment.

Referring to FIG. 6A, a processor (e.g., at least one of a processor 120 in FIG. 1, a first communication processor 212 or a second communication processor 214 in FIG. 2A, or a communication processor 260 in FIG. 2B) of an electronic device (e.g., at least one of an electronic device 101 in FIG. 1, 2A, 2B, or 6B) may select one of a transmission path based on a first radio access technology (RAT) and a transmission path based on a second RAT as a first transmission path, which is an uplink data transmission path to be used in the electronic device, for a dual connectivity communication in operation 651. In an embodiment, the first RAT may include LTE and the second RAT may include NR. The uplink data transmission path to be used in the electronic device may be referred to as a “first transmission path”. In an embodiment, the first transmission path may be an LTE transmission path.

In operation 653, the processor which selects the first transmission path may perform an operation of stopping uplink data transmission and maintaining uplink control information transmission on a second transmission path (e.g., an NR transmission path) other than the first transmission path (e.g., the LTE transmission path) among the transmission path (e.g., the LTE transmission path) based on the first RAT and the transmission path (e.g., the NR path) based on the second RAT. An embodiment of the operation of stopping the uplink data transmission and maintaining the uplink control information transmission on the second transmission path in the processor will be described in detail below with reference to FIG. 6B, so a detailed description will be omitted.

In operation 655, the processor may perform an operation of transmitting at least one of uplink data or uplink control information on the first transmission path. An embodiment of the operation of transmitting the at least one of the uplink data or the uplink control information on the first transmission path in the processor will be described in detail below with reference to FIG. 6B, so a detailed description will be omitted.

Even though FIG. 6A illustrates the operating process of the electronic device according to an embodiment, various modifications may be made to FIG. 6A. For example, although sequential operations are shown in FIG. 6A, the operations described in FIG. 6A may overlap, occur in parallel, occur in a different order, or occur multiple times.

FIG. 6B is a diagram illustrating a transmitting operation of an electronic device, according to an embodiment.

Referring to FIG. 6B, an electronic device 101 (e.g., at least one of a processor 120 in FIG. 1, a first communication processor 212 or a second communication processor 214 in FIG. 2A, or a communication processor 260 in FIG. 2B) may support an EN-DC scheme. In a protocol stack of the electronic device 101 according to an embodiment, operations for processing a communication protocol among an RRC layer, a PDCP layer, an RLC layer, a MAC layer, and a PHY layer may be performed by an RRC entity, a PDCP entity, an RLC entity, a MAC entity, and a PHY entity which are logical entities responsible for each layer. A program which defines an operation of each of the RRC entity, the PDCP entity, the RLC entity, the MAC entity, and the PHY entity based on a communication protocol may be included (for example, may be stored) in the electronic device 101. In the electronic device 101, at least one processor may control operations among the RRC entity, the PDCP entity, the RLC entity, the MAC entity, and the PHY entity according to an embodiment based on the program. In an embodiment, the at least one processor may include a communication processor (e.g., at least one of the processor 120 in FIG. 1, the first communication processor 212 or the second communication processor 214 in FIG. 2A, or the communication processor 260 in FIG. 2B).

A protocol stack of the electronic device 101 may include an LTE RRC entity 601, an NR RRC entity 603, an NR PDCP entity 611, an LTE RLC entity 621, an NR RLC entity 623, an LTE MAC entity 631, an NR MAC entity 633, an LTE PHY entity 641, and/or an NR PHY entity 643. In FIG. 6B, a transmitting operation related to an uplink split bearer will be described, so only a case that the protocol stack of the electronic device 101 includes entities related to the uplink split bearer is shown. The LTE RRC entity 601, the LTE RLC entity 621, and the LTE PHY entity 641 may be also referred to as an E-UTRA RRC entity 601, an E-UTRA RLC entity 621, and an E-UTRA PHY entity 641, respectively.

In an embodiment, the electronic device 101 may support a transmitting operation for controlling transmission paths in an uplink split bearer. Hereinafter, the transmitting operation for controlling the transmission paths in the uplink split bearer will be referred to as a “biased transmitting operation,” and a mode in which the biased transmitting operation is performed will be referred to as “biased mode.”

According to an embodiment, the biased transmitting operation may include selecting, by the electronic device 101, one of a transmission path based on a first radio access technology (RAT) (e.g., LTE) and a transmission path based on a second RAT (e.g., NR) as a first transmission path, which is an uplink data transmission path to be used in the electronic device 101, for a dual connectivity communication, performing, by the electronic device 101, an operation of stopping uplink data transmission and maintaining uplink control information transmission on a second transmission path other than the first transmission path among the transmission path based on the first RAT and the transmission path based on the second RAT, and performing, by the electronic device 101, an operation of transmitting at least one of uplink data or uplink control information on the first transmission path (for example, a full biased mode). In an embodiment, the first transmission path may be associated with a first antenna module 660 (e.g., a first antenna module 242 in FIG. 2A or 2B). In an embodiment, the second transmission path may be associated with a second antenna module 670 (e.g., a second antenna module 244 in FIG. 2A or 2B and/or a third antenna module 246 in FIG. 2A or 2B). For example, NR frequency range-2 (FR2) may be associated with the second antenna module 244 in FIG. 2A or 2B, and the NR FR2 may be associated with the third antenna module 246 in FIG. 2A or 2B. According to another embodiment, the biased transmitting operation may include adjusting, by the electronic device 101, amount of uplink data for the first transmission path and amount of uplink data for the second transmission path corresponding to a set ratio (e.g., a split ratio) for the dual connectivity communication, performing, by the electronic device 101, a transmitting operation on the first transmission path based on the adjusted amount of uplink data for the first transmission path, and performing, by the electronic device 101, a transmitting operation on the second transmission path based on the adjusted amount of uplink data for the second transmission path (e.g., a partial biased mode).

According to an embodiment, in the biased transmitting operation, if the split ratio is used, it may be possible for at least one of the uplink data or the uplink control information to be transmitted through both the first transmission path and the second transmission path. In this case, amount of uplink data transmitted through the first transmission path and amount of uplink data transmitted through the second transmission path may be determined corresponding to the split ratio. In an embodiment, the split ratio may represent a ratio of the amount of the uplink data transmitted through the first transmission path to the amount of the uplink data transmitted through the second transmission path. The split ratio may be determined based on a ratio of a data rate of uplink transmission through the first transmission path and a data rate of uplink transmission through the second transmission path, may be determined based on a set ratio, may be determined based on the number of times a power scale down operation is performed on the second transmission path during a set period, or may be determined based on a combination thereof. In an embodiment, if the split ratio is determined based on the set ratio, the split ratio may be determined by adjusting the set ratio by a set unit (e.g., a step size), and if these ratio adjustments are accumulated, the split ratio suitable for an uplink split bearer environment may be determined.

In an embodiment, the biased mode may be activated based on a trigger condition, may be activated based on user interaction, and/or may be activated based on based on higher layer signaling (e.g., an RRC message), which is received from a network (e.g., a base station), for activating the biased mode.

In an embodiment, the biased mode may be maintained based on a timer. For example, the timer may start at a time point when the biased mode is activated, and the biased mode may be deactivated at a time point when the timer expires. For another example, while the timer is running as the biased mode is activated, if the biased mode is deactivated, the timer may be stopped. In an embodiment, a value of the timer may be set to suit a system situation and may be set to a default value when initially driven.

In the biased mode according to an embodiment, if power saving is required or inefficient transmission occurs during uplink transmission, the NR PDCP entity 611 may prevent uplink data from being distributed to entities associated with a transmission path in which uplink transmission may be omitted based on an LTE capability and/or an NR capability.

In the biased mode, the NR PDCP entity 611 may select a transmission path (e.g., an uplink data transmission path) on which an uplink data transmitting operation will be performed in the uplink split bearer. In an embodiment, the uplink data transmission path may be a first transmission path. In an embodiment, a transmitting operation may be stopped (or may be dropped, or may be skipped) on a transmission path (e.g., a second transmission path) other than the transmission path selected in the uplink split bearer. An embodiment of the operation in which the NR PDCP entity 611 selects the transmission path (e.g., the uplink data transmission path) on which the uplink data transmitting operation will be performed in the uplink split bearer will be described below, so a detailed description thereof will be omitted herein. The NR PDCP entity 611 may transfer a biased mode indicator indicating that the biased mode is activated to lower entities corresponding to a transmission path (e.g., a transmission path in which an uplink data transmitting operation will be stopped and an uplink control information transmitting operation will be maintained) other than the selected transmission path (e.g., a transmission path in which at least one of the uplink data transmitting operation or an uplink control information transmitting operation) in which the uplink data transmitting operation will be performed. For example, if a value of the biased mode indicator is “1”, it may indicate that the biased mode is activated. In the uplink split bearer, if a transmission path (e.g., an LTE transmission path) corresponding to an LTE system is selected, lower entities to which the biased mode indicator is transferred may include the NR RLC entity 623, the NR MAC entity 633, and/or the NR PHY entity 643.

The lower entities which receives the biased mode indicator from the NR PDCP entity 611 may identify that the biased mode is activated based on the received biased mode indicator. The lower entities which identifies that the biased mode is activated may identify that the uplink data transmitting operation on a corresponding transmission path will be stopped. According to an embodiment, the biased mode indicator may not only indicate that the biased mode is activated, but also indicate that the uplink data transmitting operation will be stopped in a corresponding entity which receives the biased mode indicator. In an embodiment, each of the lower entities which identify that the biased mode is activated may run a timer.

If the electronic device 101 operates in the biased mode, dual connectivity and uplink split bearer configuration configured in the electronic device 101 may be maintained, and only uplink data transmitting operation through some transmission paths on the uplink split bearer may be stopped temporarily (for example, during a time period during which uplink data transmitting operation through a corresponding transmission path is unnecessary). If the electronic device 101 operates in the biased mode, the dual connectivity and uplink split bearer configuration configured in the electronic device 101 may be maintained, and only the uplink data transmitting operation through some transmission paths on the uplink split bearer may be stopped temporarily. Therefore, without changing the dual connectivity and uplink split bearer configuration configured for the electronic device 101 in a network, the electronic device 101 may dynamically select a transmission path (e.g., an uplink data transmission path) on which an uplink data transmitting operation will be performed as needed, and stop an uplink data transmitting operation on a transmission path other than the selected transmission path, thereby power consumption of the electronic device 101 may be reduced.

In an embodiment, the electronic device 101 may perform a biased transmitting operation by performing at least part of the following operations.

(1) Operation of determining whether to activate a biased mode.

(2) Operation of selecting a transmission path (e.g., an uplink data transmission path) on which an uplink data transmitting operation will be performed among transmission paths on an uplink split bearer if it is determined to activate the biased mode.

(3) Operation of performing a transmitting operation through the selected transmission path and stopping an uplink data transmitting operation on the transmission path other than the selected transmission path.

In an embodiment, the electronic device 101 may identify whether the biased mode is supported, and this will be described as follows.

The electronic device 101 may identify whether an uplink split bearer is configured in the electronic device 101. If the uplink split bearer is configured in the electronic device 101, the electronic device 101 may check whether it is possible to skip uplink transmission on a transmission path related to a biased transmitting operation. In an embodiment, the electronic device 101 may identify whether it is possible to skip uplink transmission on an LTE transmission path based on skipUplinkDynamic, and may identify whether it is possible to skip uplink transmission on an NR transmission path based on skipUplinkTxDynamic. In an embodiment, skipUplinkDynamic and skipUplinkTxDynamic may be provided to the electronic device 101 through higher layer (or higher entity) (e.g., RRC entity) signaling. In an embodiment, skipUplinkDynamic and skipUplinkTxDynamic may be provided to the electronic device 101 through an RRC reconfiguration message. For example, if skipUplinkDynamic is set to true, the electronic device 101 may skip the uplink transmission on the LTE transmission path, and if skipUplinkTxDynamic is set to true, the electronic device 101 may skip the uplink transmission on the NR transmission path. If it is possible to skip uplink transmission on at least one of the transmission paths (e.g., the LTE transmission path and the NR transmission path) associated with the biased transmitting operation, the electronic device 101 may identify that the biased mode is supported. If an uplink split bearer is not configured in the electronic device 101, or if it is impossible to skip uplink transmission on all of the transmission paths related to the biased transmitting operation even though the uplink split bearer is configured in the electronic device 101, the electronic device 101 may identify that the biased mode is not supported.

In an embodiment, the electronic device 101 which identifies that the biased mode is supported may determine whether to activate the biased mode. An operation in which the electronic device 101 determines whether to activate the biased mode will be described as follows.

The electronic device 101 may determine whether to activate the biased mode based on a trigger condition, or may determine whether to activate the biased mode based on user interaction, or may determine whether to activate the biased mode based on higher layer signaling received from a network (e.g., a base station), or may determine whether to activate the biased mode based on a combination thereof.

An operation in which the electronic device 101 determines whether to activate the biased mode based on the trigger condition, according to an embodiment, will be described as follows.

In an embodiment, the trigger condition may include (1) a condition in which transmission power is wasted in a transmission path, (2) a condition in which uplink transmission is stopped (for example, dropped) in the transmission path, and (3) a condition in which an operation for reducing transmission power is performed, and/or a combination thereof. The electronic device 101 may determine to activate the biased mode if the trigger condition is satisfied.

In an embodiment, if a power scale down operation is performed with transmission power less than X_{SCALE} which is first threshold transmission power on a specific transmission path (e.g., an NR transmission path) associated with an uplink split bearer and a transmission operation is performed, and reduced transmission power for the NR transmission path according to the power scale down operation is greater than or equal to second threshold transmission power, uplink data transmitted through the NR transmission path does not normally reach a receiving device (e.g., a base station), so a communication processor may predict that transmission failure may occur. If the transmission failure occurs on the NR transmission path, the communication processor may consider that transmission power is wasted.

In an embodiment, if the communication processor detects that a transmission error greater than or equal to a threshold level occurs, or detects that transmission failure greater than or equal to a threshold level occurs, on the specific transmission path (e.g., the NR transmission path) associated with the uplink split bearer, the communication processor may consider that transmission power is wasted. In an embodiment, if an error rate is greater than or equal to a threshold error rate, the communication processor may detect that the transmission error greater than or equal to the threshold level occurs. For example, the error rate may include a block error rate (BLER), and/or a frame error rate (FER). In an embodiment, if the number of negative acknowledgments (NACKs) is greater than or equal to a threshold number, or the number of consecutive NACKs is greater than or equal to the threshold number, or the number of NACKs during a set time period is greater than or equal to the threshold number, the communication processor may detect that the transmission error greater than or equal to the threshold level occurs.

In an embodiment, the communication processor may consider that the transmission power is wasted on the particular transmission path (e.g., the NR transmission path) on the uplink split bearer according to detection of a handgrip. For example, when detecting the hand grip, the communication processor may identify that there is limitation on a communication through the NR transmission path, and in this case, the communication processor may consider that the transmission power is wasted.

In an embodiment, the communication processor may consider that the transmission power is wasted on the particular transmission path (e.g., the NR transmission path) on the uplink split bearer as the communication processor detects that a situation in which an uplink radio resource is wasted occurs. For example, when MAC entities (e.g., an LTE MAC entity and an NR MAC entity) associated with transmission paths transmit a BSR, data volume of a PDCP entity (e.g., an NR PDCP entity) may be considered in both the LTE MAC entity and the NR MAC entity, and consequently, the data volume of the NR PDCP entity may be considered redundantly. As such, as the data volume of the NR PDCP entity is redundantly reflected in BSRs, an uplink radio resource whose amount exceeds amount of an uplink radio resource which the electronic device 101 actually needs may be allocated from base stations (e.g., an eNB and a gNB) to the electronic device 101. In the uplink radio resource allocated from the base stations, uplink data is transmitted through a transport block (TB), and padding transmission, in which padding bits are included in a payload of the TB and transmitted, may occur because the uplink radio resource, whose amount is more than amount of an uplink radio resource appropriate for amount of uplink data to be actually transmitted, is allocated. If the padding transmission occurs, the communication processor may consider that transmission power is wasted.

In an embodiment, if X_{SCALE} is applied for the specific transmission path (e.g., the NR transmission path) associated with the uplink split bearer and the power scale down operation is performed with power difference which is greater than or equal to threshold power difference xScale on the corresponding transmission path, the communication processor may detect that uplink transmission is stopped on the corresponding transmission path.

In an embodiment, the communication processor may detect that an operation for reducing transmission power is performed if indication requesting to reduce the transmission power is received from the application processor. For example, if capacity of a battery (e.g., a battery 189 in FIG. 1) of the electronic device 101 is less than or equal to a threshold battery capacity, the application processor may transfer the indication requesting to reduce the transmission power to the communication processor.

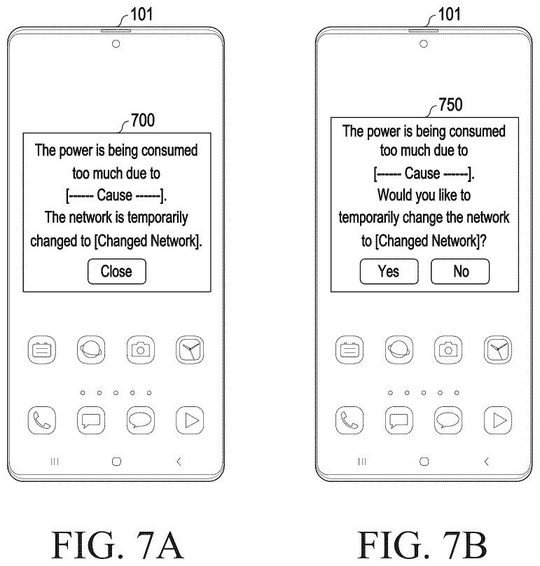

An embodiment of an operation in which the electronic device 101 determines whether to activate the biased mode based on user interaction will be described with reference to FIGS. 7A and 7B, 8A and 8B, and 9A and 9B.

FIG. 7A is a diagram illustrating a message indicating setting of a biased mode, according to an embodiment.

Referring to FIG. 7A, a message 700 indicating setting of a biased mode may be a message indicating that the biased mode is activated. A communication processor (e.g., at least one of a processor 120 in FIG. 1, a first communication processor 212 or a second communication processor 214 in FIG. 2A, or a communication processor 260 in FIG. 2B) of the electronic device 101 may determine whether to activate the biased mode when identifying that the biased mode is supported.

When identifying that the biased mode needs to be activated, the communication processor may transfer an alarm informing that the biased mode needs to be activated to an application processor. In an embodiment, the communication processor may identify that the biased mode needs to be activated based on a trigger condition (for example, at least one of (1) a condition under which transmission power is wasted on a transmission path, (2) a condition under which uplink transmission is stopped (e.g., dropped) on a transmission path, and/or (3) a condition under which an operation for reducing transmission power is performed), and the trigger condition may be implemented to be similar to or substantially the same as that described with reference to FIG. 6B, so a detailed description thereof will be omitted. In an embodiment, the alarm informing that the biased mode needs to be activated may be transferred from the communication processor to the application processor via an interface between the communication processor and the application processor. In an embodiment, the alarm informing that the biased mode needs to be activated may include information about a cause it is necessary to activate the biased mode and a transmission path which is selected (for example, on which an uplink data transmitting operation will be performed) on an uplink split bearer.

The application processor may receive, from the communication processor, the alarm informing that the biased mode needs to be activated, and output the message 700 indicating the setting of the biased mode via a user interface (UI). In an embodiment, the message 700 indicating the setting of the biased mode may notify that the biased mode is activated, and may include information about a cause it is necessary to activate the biased mode and a transmission path on which an uplink data transmitting operation will be performed as the biased mode is activated. In FIG. 7A, the message 700 indicating the setting of the biased mode may be implemented as “The power is being consumed too much due to [—Cause—]. The network is temporarily changed to [Changed Network]”, the information about the cause it is necessary to activate the biased mode may be included in the part “[—Cause—]”, and the information about the transmission path on which the uplink data transmitting operation will be performed on the uplink split bearer may be included in the part [Changed Network].

The application processor, which outputs the message 700 indicating the setting of the biased mode, may transfer, to the communication processor, an alarm informing that the message 700 indicating the setting of the biased mode setting is outputted via the interface between the communication processor and the application processor. The communication processor which receives, from the application processor, the alarm informing that the message 700 indicating the setting of the biased mode setting is outputted, may determine to activate the biased mode. Alternatively, the communication processor may determine to activate the biased mode based on the transmission of the alarm informing that the biased mode needs to be activated. Alternatively, the communication processor may also activate the biased mode if an user input (e.g., designation of a “close” button) for the message 700 indicating the setting of the biased mode is identified from the application processor, and there may be no limitation on a time point at which the biased mode is set.

FIG. 7B is a diagram illustrating a biased mode control message, according to an embodiment.

Referring to FIG. 7B, a biased mode control message 750 may be a message used for an electronic device 101 (e.g., an electronic device 101 in FIG. 1, 2A, or 2B) to determine whether to activate a biased mode. The electronic device 101 may determine whether to activate the biased mode based on an user interaction when identifying that the biased mode is supported.

When identifying that the biased mode needs to be activated, a communication processor (e.g., at least one of a processor 120 in FIG. 1, a first communication processor 212 or a second communication processor 214 in FIG. 2A, or a communication processor 260 in FIG. 2B) of the electronic device 101 may transfer an alarm informing that the biased mode needs to be activated to an application processor. In an embodiment, the communication processor may identify that the biased mode needs to be activated based on a trigger condition (for example, at least one of (1) a condition under which transmission power is wasted on a transmission path, (2) a condition under which uplink transmission is stopped (e.g., dropped) on a transmission path, and/or (3) a condition under which an operation for reducing transmission power is performed), and the trigger condition may be implemented to be similar to or substantially the same as that described with reference to FIG. 6B, and a detailed description thereof will be omitted. In an embodiment, the alarm informing that the biased mode needs to be activated may be implemented to be similar to or substantially the same as that described with reference to FIG. 7A, and a detailed description thereof will be omitted.

The application processor may receive, from the communication processor, the alarm informing that the biased mode needs to be activated, and output the biased mode control message 750 via an UI. In an embodiment, the biased mode control message 750 may inquire whether to activate the biased mode, and may include information about a cause it is necessary to activate the biased mode and a transmission path on which an uplink data transmitting operation will be performed as the biased mode is activated. In FIG. 7B, the biased mode control message 750 may be implemented as “The power is being consumed too much due to [—Cause—]. Would you like to temporarily change the network to [Change Network]?”, the information about the cause it is necessary to activate the biased mode may be included in the part “[—Cause—]”, and the information about the transmission path on which the uplink data transmitting operation will be performed on the uplink split bearer may be included in the part [Changed Network].

When detecting an user input (e.g., an input of “Yes” icon within the biased mode control message 750) requesting to change the network via the UI after outputting the biased mode control message 750, the application processor may transfer an alarm requesting to activate the biased mode to the communication processor via the interface between the communication processor and the application processor. In an embodiment, the user input requesting to change the network may be considered as requesting to activate the biased mode, so the application processor may transfer the alarm requesting to activate the biased mode to the communication processor. The communications processor, which receives the alarm requesting to activate the biased mode from the application processor, may determine to activate the biased mode.

In FIG. 7B, the user input requesting to change the network (e.g., the user input requesting to activate the biased mode) via the biased mode control message 750 outputted by the application processor may be an user interaction, so the communication processor may activate the biased mode when receiving the alarm requesting to activate the biased mode from the application processor.

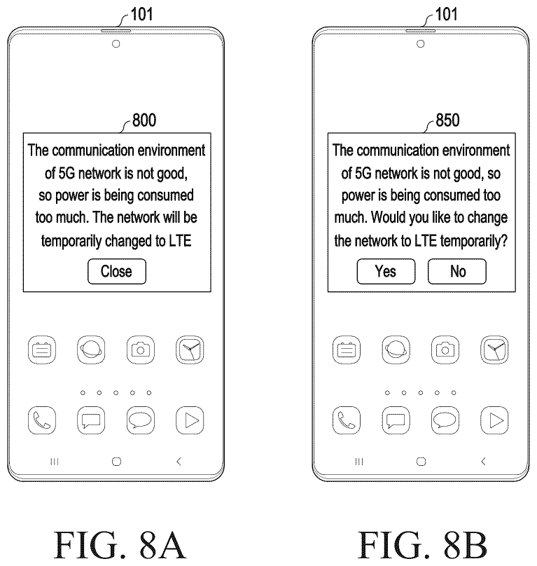

FIG. 8A is a diagram illustrating a message indicating setting of a biased mode, according to an embodiment.

Referring to FIG. 8A, a message 800 indicating setting of a biased mode may be a message indicating setting of a biased mode in a case that a cause it is necessary for the biased mode to be activated is that a condition under which transmission power is wasted on a specific transmission path on an uplink transmission bearer is satisfied (for example, if a transmission error which is greater than or equal to a threshold level occurs on an NR transmission path, or transmission failure which is greater than or equal to a threshold level occurs), and a transmission path on which an uplink transmitting operation is performed as the biased mode is activated is an LTE transmission path.

A communication processor (e.g., at least one of a processor 120 in FIG. 1, a first communication processor 212 or a second communication processor 214 in FIG. 2A, or a communication processor 260 in FIG. 2B) of an electronic device 101 of an electronic device 101 (e.g., an electronic device 101 in FIG. 1, 2A, or 2B) may detect that the condition, under which the transmission power is wasted on the specific transmission path (e.g., the NR transmission path) on the uplink transmission bearer, is satisfied (for example, if the transmission error which is greater than or equal to the threshold level occurs, or the transmission failure which is greater than or equal to the threshold level occurs), and transfer, to an application processor, an alarm informing that it is necessary to activate the biased mode as it is detected that the condition, under which the transmission power is wasted on the corresponding transmission path, is satisfied. In an embodiment, the alarm informing that it is necessary to activate the biased mode may be transferred from the communication processor to the application processor via an interface between the communication processor and the application processor. In an embodiment, the alarm informing that it is necessary to activate the biased mode may include information indicating that a cause it is necessary for the biased mode to be activated is that the condition, under which the transmission power is wasted on the specific transmission path on the uplink transmission bearer, is satisfied, and the transmission path on which the uplink transmitting operation will be performed is the LTE transmission path.

The application processor may receive, from the communication processor, the alarm informing that it is necessary to activate the biased mode, and output the message 800 indicating setting of the biased mode via an UI. In an embodiment, the message 800 indicating the setting of the biased mode may be implemented as “The communication environment of 5G network is not good, so power is being consumed too much. The network will be temporarily changed to LTE.”

The application processor, which outputs the message 800 indicating the setting of the biased mode, may transfer, to the communication processor, an alarm informing that the message 800 indicating the setting of the biased mode setting is outputted via the interface between the communication processor and the application processor. The communication processor which receives, from the application processor, the alarm informing that the message 800 indicating the setting of the biased mode setting is outputted, may determine to activate the biased mode. Alternatively, the communication processor may determine to activate the biased mode based on the transmission of the alarm informing that the biased mode needs to be activated. Alternatively, the communication processor may also activate the biased mode if an user input (e.g., designation of a “close” button) for the message 800 indicating the setting of the biased mode is identified from the application processor, and there may be no limitation on a time point at which the biased mode is set.

FIG. 8B is a diagram illustrating a biased mode control message, according to an embodiment.

Referring to FIG. 8B, a biased mode control message 850 may be a biased mode control message in a case that a cause it is necessary for the biased mode to be activated is that a condition, under which transmission power is wasted on a specific transmission path on an uplink transmission bearer, is satisfied (for example, if a transmission error which is greater than or equal to a threshold level occurs on an NR transmission path, or transmission failure which is greater than or equal to a threshold level occurs), and a transmission path on which an uplink transmitting operation is performed as the biased mode is activated is an LTE transmission path.

A communication processor (e.g., at least one of a processor 120 in FIG. 1, a first communication processor 212 or a second communication processor 214 in FIG. 2A, or a communication processor 260 in FIG. 2B) of an electronic device 101 (e.g., an electronic device 101 in FIG. 1, 2A, or 2B) may detect that the condition, under which the transmission power is wasted on the specific transmission path (e.g., the NR transmission path) on the uplink transmission bearer, is satisfied (for example, if the transmission error which is greater than or equal to the threshold level occurs, or the transmission failure which is greater than or equal to the threshold level occurs), and transfer, to an application processor, an alarm informing that it is necessary to activate the biased mode as it is detected that the condition, under which the transmission power is wasted on the corresponding transmission path, is satisfied. In an embodiment, the alarm informing that it is necessary to activate the biased mode may be transferred from the communication processor to the application processor via an interface between the communication processor and the application processor. In an embodiment, the alarm informing that it is necessary to activate the biased mode may include information indicating that a cause it is necessary for the biased mode to be activated is that the condition, under which the transmission power is wasted on the specific transmission path on the uplink transmission bearer, is satisfied, and the transmission path on which the uplink transmitting operation will be performed is the LTE transmission path.

The application processor may receive, from the communication processor, the alarm informing that it is necessary to activate the biased mode, and output the biased mode control message 850 via an UI. In an embodiment, the biased mode control message 850 may be implemented as “The communication environment of 5G network is not good, so power is being consumed too much. Would you like to change the network to LTE temporarily?”.

When detecting an user input (e.g., an input of “Yes” icon within the biased mode control message 850) requesting to change the network via the UI after outputting the biased mode control message 850, the application processor may transfer an alarm requesting to activate the biased mode to the communication processor via the interface between the communication processor and the application processor. In an embodiment, the user input requesting to change the network may be considered as requesting to activate the biased mode, so the application processor may transfer the alarm requesting to activate the biased mode to the communication processor. The communications processor, which receives the alarm requesting to activate the biased mode from the application processor, may determine to activate the biased mode.

In FIG. 8B, the user input requesting to change the network (e.g., the user input requesting to activate the biased mode) via the biased mode control message 850 outputted by the application processor may be an user interaction, so the communication processor may activate the biased mode when receiving the alarm requesting to activate the biased mode from the application processor.

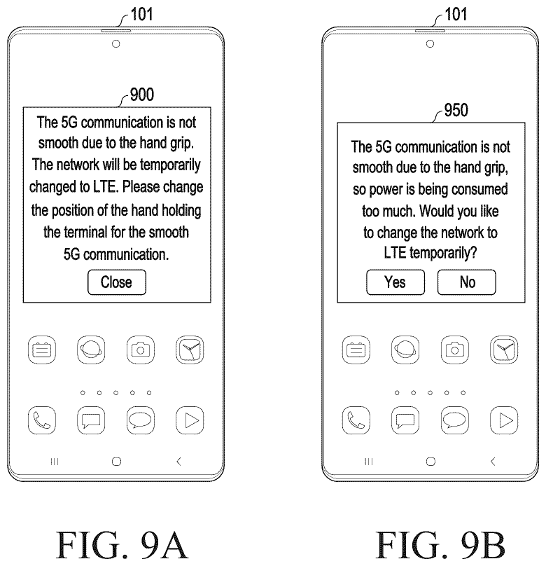

FIG. 9A is a diagram illustrating a message indicating setting of a biased mode, according to an embodiment.

Referring to FIG. 9A, a message 900 indicating setting of a biased mode may be a message indicating setting of a biased mode in a case that a cause it is necessary for the biased mode to be activated is that a condition, under which transmission power is wasted on a specific transmission path on an uplink transmission bearer, is satisfied (for example, if there is a limitation on a communication on an NR transmission path according to detection of a hand grip), and a transmission path on which an uplink transmitting operation is performed as the biased mode is activated is an LTE transmission path. A communication processor (e.g., at least one of a processor 120 in FIG. 1, a first communication processor 212 or a second communication processor 214 in FIG. 2A, or a communication processor 260 in FIG. 2B) of an electronic device 101 of an electronic device 101 (e.g., at least one of an electronic device 101 in FIG. 1, 2A, or 2B) may detect that the condition, under which the transmission power is wasted on the specific transmission path (e.g., the NR transmission path) on the uplink transmission bearer, is satisfied (for example, if there is the limitation on the communication according to the detection of the hand grip), and transfer, to an application processor, an alarm informing that it is necessary to activate the biased mode as it is detected that the condition, under which the transmission power is wasted on the corresponding transmission path, is satisfied. In an embodiment, the alarm informing that it is necessary to activate the biased mode may be transferred from the communication processor to the application processor via an interface between the communication processor and the application processor. In an embodiment, the alarm informing that it is necessary to activate the biased mode may include information indicating that a cause it is necessary for the biased mode to be activated is that the condition, under which the transmission power is wasted on the specific transmission path on the uplink transmission bearer, is satisfied due to the hand grip, and the transmission path on which the uplink transmitting operation will be performed is the LTE transmission path.

The application processor may receive, from the communication processor, the alarm informing that it is necessary to activate the biased mode, and output the message 900 indicating setting of the biased mode via an UI. In an embodiment, the message 900 indicating the setting of the biased mode may be implemented as “The communication environment of 5G network is not smooth due to the hand grip. The network will be temporarily changed to LTE. Please change the position of the hand holding the terminal for the smooth 5G communication.”

The application processor, which outputs the message 900 indicating the setting of the biased mode, may transfer, to the communication processor, an alarm informing that the message 900 indicating the setting of the biased mode setting is outputted via the interface between the communication processor and the application processor. The communication processor which receives, from the application processor, the alarm informing that the message 900 indicating the setting of the biased mode setting is outputted, may determine to activate the biased mode. Alternatively, the communication processor may determine to activate the biased mode based on the transmission of the alarm informing that the biased mode needs to be activated. Alternatively, the communication processor may also activate the biased mode if an user input (e.g., designation of a “close” button) for the message 900 indicating the setting of the biased mode is identified from the application processor, and there may be no limitation on a time point at which the biased mode is set.

FIG. 9B is a diagram illustrating a biased mode control message, according to an embodiment.

Referring to FIG. 9B, a biased mode control message 950 may be a biased mode control message in a case that a cause it is necessary for the biased mode to be activated is that a condition, under which transmission power is wasted on a specific transmission path on an uplink transmission bearer, is satisfied (for example, if there is a limitation on a communication according to detection of a hand grip), and a transmission path on which an uplink transmitting operation is performed as the biased mode is activated is an LTE transmission path.

A communication processor (e.g., at least one of a processor 120 in FIG. 1, a first communication processor 212 or a second communication processor 214 in FIG. 2A, or a communication processor 260 in FIG. 2B) of an electronic device 101 (e.g., at least one of an electronic device 101 in FIG. 1, 2A, or 2B) may detect that the condition, under which the transmission power is wasted on the specific transmission path (e.g., the NR transmission path) on the uplink transmission bearer, is satisfied (for example, if there is the limitation on the communication according to the detection of the hand grip), and transfer, to an application processor, an alarm informing that it is necessary to activate the biased mode as it is detected that the condition, under which the transmission power is wasted on the corresponding transmission path, is satisfied. In an embodiment, the alarm informing that it is necessary to activate the biased mode may be transferred from the communication processor to the application processor via an interface between the communication processor and the application processor. In an embodiment, the alarm informing that it is necessary to activate the biased mode may include information indicating that a cause it is necessary for the biased mode to be activated is that the condition, under which the transmission power is wasted on the specific transmission path on the uplink transmission bearer, is satisfied due to the hand grip, and the transmission path on which the uplink transmitting operation will be performed is the LTE transmission path.

The application processor may receive, from the communication processor, the alarm informing that it is necessary to activate the biased mode, and output the biased mode control message 950 via an UI. In an embodiment, the biased mode control message 950 may be implemented as “The 5G communication is not smooth due to the hand grip, so power is being consumed too much. Would you like to change the network to LTE temporarily?”.

When detecting an user input (e.g., an input of “Yes” icon within the biased mode control message 950) requesting to change the network via the UI after outputting the biased mode control message 950, the application processor may transfer an alarm requesting to activate the biased mode to the communication processor via the interface between the communication processor and the application processor. In an embodiment, the user input requesting to change the network may be considered as requesting to activate the biased mode, so the application processor may transfer the alarm requesting to activate the biased mode to the communication processor. The communications processor, which receives the alarm requesting to activate the biased mode from the application processor, may determine to activate the biased mode.

In FIG. 9B, the user input requesting to change the network (e.g., the user input requesting to activate the biased mode) via the biased mode control message 950 outputted by the application processor may be an user interaction, so the communication processor may activate the biased mode when receiving the alarm requesting to activate the biased mode from the application processor.

The message indicating the setting of the bias mode and the biased mode control message described in FIGS. 7A and 7B, 8A and 8B, and 9A and 9B may be implemented in various forms such as a pop-up, an icon, and/or vibration.

The operation in which the electronic device 101 determines whether to activate the biased mode based on the higher layer signaling received from the network (e.g., the base station) according to an embodiment will be described as follows.

In an embodiment, the network may directly control activation of the biased mode and an uplink data transmission path to be used in the biased mode, or may directly control the activation of the biased mode and control the uplink data transmission path to be used in the biased mode to be controlled by the electronic device 101.

According to an embodiment, a scheme in which the network directly controls the activation of the biased mode and the uplink data transmission path to be used in biased mode will be described as follows.

The network may inform the electronic device 101 of information indicating the activation of the biased mode and information about the uplink data transmission path to be used in the biased mode through upper layer signaling (e.g., an RRC message). The higher layer signaling which informs the electronic device 101 of the information indicating the activation of the biased mode and the information about the uplink data transmission path to be used in the biased mode may be an RRC reconfiguration message.

For example, the RRC reconfiguration message may include ul-DataSplitThreshold and PrimaryPath. ul-DataSplitThreshold may indicate threshold data volume, and may be implemented to be similar to or substantially the same as described in FIG. 4. PrimaryPath may indicate a cell group identifier (ID) and a logical channel ID (LCID) of a primary RLC entity for uplink data transmission when one or more RLC entities are associated with a PDCP entity. For example, if a value of ul-DataSplitThreshold is a second value (e.g., infinity) and PrimaryPath exists, it may indicate that a full biased mode is activated and a transmission path corresponding to PrimaryPath will be used in the full biased mode. In an embodiment, the full biased mode may represent a biased mode in which uplink data transmission is not performed and only uplink control information transmission is performed through a specific transmission path (e.g., an NR transmission path) among transmission paths corresponding to an uplink split bearer. For example, if the value of ul-DataSplitThreshold is a third value and PrimaryPath exists, it may indicate that a partial biased mode is activated, and a transmission path corresponding to PrimaryPath and the remaining transmission path (e.g., a secondary transmission path) will be used in the partial biased mode. In an embodiment, the partial biased mode may represent a biased mode in which amount of uplink data is adjusted corresponding to a split ratio and then an uplink transmission operation is performed on transmission paths corresponding to the uplink split bearer. In an embodiment, if the value of DataSplitThreshold is the third value, it may indicate activation of the partial biased mode in which an uplink transmitting operation is performed on both a primary path and a secondary path, but a transmitting operation is mainly performed through the primary path. A ratio between data volume transmitted on the primary path and data volume transmitted on the secondary path in the partial biased mode may be the split ratio.

For example, the RRC reconfiguration message may include new parameters, which indicate the activation of the biased mode and the uplink data transmission path to be used in the biased mode, other than ul-DataSplitThreshold and PrimaryPath. For example, if a value of a first parameter (e.g., an indicator) indicating the activation of the biased mode is a first value, it may indicate that the full biased mode is performed. If the value of the first parameter indicating the activation of the biased mode is a second value, it may indicate that the partial biased mode is performed. If a value of a second parameter indicating an uplink data transmission path to be used in the biased mode is a first value, it may indicate that the primary path is used in the biased mode. If the value of the second parameter indicating the uplink data transmission path to be used in the biased mode is a second value, it may indicate that the secondary path is used in the biased mode. If the value of the first parameter indicating the activation of the biased mode is the second value, the RRC reconfiguration message may include a third parameter indicating the split ratio.

In an embodiment, the network may directly control the activation of the biased mode, and control the uplink data transmission path to be used in the biased mode to be controlled by the electronic device 101.

The network may inform the electronic device 101 of the activation of the biased mode through higher layer signaling (e.g., an RRC message). The higher layer signaling which informs the electronic device 101 of the activation of the biased mode may be an RRC reconfiguration message. The RRC reconfiguration message may include the first parameter indicating the activation of the biased mode, and if the value of the first parameter indicating the activation of the biased mode is the first value, it may indicate that the full biased mode is performed. If the value of the first parameter indicating the activation of the biased mode is the second value, it may indicate that the partial biased mode is performed. If the value of the first parameter indicating the activation of the biased mode is the second value, the RRC reconfiguration message may include the third parameter indicating the split ratio.

The electronic device 101 which receives the RRC reconfiguration message including the first parameter may identify whether the full biased mode is activated or the partial biased mode is activated based on the value of the first parameter. If the full biased mode is activated, the electronic device 101 may select an uplink data transmission path to be used in the full biased mode. If the partial biased mode is activated, the electronic device 101 may select a primary path and a secondary path to be used in the partial biased mode.

In an embodiment, the electronic device 101 which determines to activate the biased mode may select the uplink data transmission path to be used in the biased mode, and this will be described as follows.

The electronic device 101 may select the uplink data transmission path to be used in the biased mode based on capability (e.g., UE radio capability) of the electronic device 101 on each transmission path. In an embodiment, the electronic device 101 may select the uplink data transmission path to be used in the biased mode based on skipUplinkDynamic and skipUplinkTxDynamic related to whether it is possible to stop (for example, skip) a transmission operation if there is no upper layer data to transmit even though an uplink resource is allocated in a PHY layer. In an embodiment, skipUplinkDynamic and skipUplinkTxDynamic may be provided to the electronic device 101 through higher layer signaling (e.g., an RRC message). If skipUplinkDynamic is set to true, the electronic device 101 may identify that it is supported to skip uplink transmission in an LTE transmission path. If skipUplinkTxDynamic is set to true, the electronic device 101 may identify that it is supported to skip uplink transmission in an NR transmission path. The electronic device 101 may identify transmission paths for which it is supported to skip uplink transmission based on skipUplinkDynamic and skipUplinkTxDynamic, so the electronic device 101 may select an uplink data transmission path to be used in the biased mode based on the transmission paths for which it is supported to skip the uplink transmission. The electronic device 101 may prevent uplink data from being distributed to a transmission path other than the selected transmission path.

When selecting the uplink data transmission path to be used in the biased mode based on skipUplinkDynamic and skipUplinkTxDynamic, the electronic device 101 may maintain configuration for dual connectivity and uplink split bearer configured in the network even though stopping uplink data transmission on a transmission path other than the selected transmission path as necessary. Therefore, without changing the dual connectivity and uplink split bearer configuration configured for the electronic device 101 in a network, the electronic device 101 may dynamically select a transmission path on which an uplink data transmitting operation will be performed as needed, and stop an uplink data transmitting operation on a transmission path other than the selected transmission path, thereby reducing power consumption of the electronic device 101. In an embodiment, the electronic device 101 may consider selecting a transmission path (e.g., an LTE transmission path) to a 4G network in an EN-DC environment as a transmission path to focus on uplink transmission. For this, skipUplinkTxDynamic may need to be set to true.

In an embodiment, if all of skipUplinkDynamic and skipUplinkTxDynamic are set to true, the electronic device 101 may identify that it is supported to skip uplink transmission on all of the LTE transmission path and the NR transmission path. If it is supported to skip the uplink transmission on all of the LTE transmission path and the NR transmission path, the electronic device 101 may select one of the LTE transmission path and the NR transmission path as the uplink data transmission path to be used in the biased mode based on channel quality, a transmission characteristic, and/or required transmission power in each of the LTE transmission path and the NR transmission path. In an embodiment, the channel quality may be expressed as at least one of a received signal strength indicator (RSSI), a channel quality indicator (CQI), a signal to noise ratio (SNR), a signal to interference ratio (SIR), a signal to interference and noise ratio (SINR), reference signal received power (RSRP), or reference signal received quality (RSRQ).

For example, in the EN-DC environment, a case where skipUplinkTxDynamic is set to true may be considered. If skipUplinkTxDynamic is set to true, uplink transmission through the NR transmission path may be skipped, so the electronic device 101 may skip uplink data transmission for the NR transmission path even though an uplink radio resource for the NR transmission path is allocated from the network. In this case, the electronic device 101 may maintain the configuration for dual connectivity and uplink split bearer, and stop only uplink data transmission through the NR transmission path if necessary.

On the uplink split bearer, a BSR transmitting operation for radio resource request may be performed on all of the LTE transmission path and the NR transmission path. For example, if it is not supported to skip the uplink transmission on the NR transmission path (for example, if skipUplinkTxDynamic is not set to true), even though the electronic device 101 determines to stop the uplink transmission on the NR transmission path, an uplink radio resource may be allocated for the NR transmission path, so a case may occur that transmission (e.g., padding transmission) including padding data may be unnecessarily performed in an NR PHY entity. For another example, if it is not supported to skip the uplink transmission on the LTE transmission path (for example, if skipUplinkDynamic is not set to true), even though the electronic device 101 determines to stop the uplink transmission on the LTE transmission path, an uplink radio resource may be allocated for the LTE transmission path, so a case may occur that transmission including padding data may be unnecessarily performed in an LTE PHY entity.

Therefore, in an embodiment of the disclosure, after selecting the uplink data transmission path (e.g., a first transmission path) to be used in the biased mode, the electronic device 101 may transfer a biased mode indicator indicating that the biased mode is activated to entities associated with a transmission path (e.g., a second transmission path (e.g., a transmission path on which uplink data transmission will be stopped and uplink control information transmission will be maintained)) other than the selected transmission path. In an embodiment, an operation of selecting the uplink data transmission path to be used in the biased mode and an operation of transferring the biased mode indicator indicating that the biased mode is activated to the entities associated with the second transmission path other than the selected first transmission path may be performed in the NR PDCP entity 611.

The NR PDCP entity 611 may transfer the biased mode indicator to lower entities (e.g., the NR RLC entity 623, the NR MAC entity 633, and the NR PHY entity 643) associated with the second transmission path (e.g., the NR transmission path). For example, if a value of the biased mode indicator is “1”, it may indicate that the biased mode is activated. The lower entities which receive the biased mode indicator from the NR PDCP entity 611 may identify that the biased mode is activated based on the biased mode indicator, and each of the lower entities which identify that the biased mode is activated may perform a transmission skipping operation for stopping an uplink data transmitting operation in a corresponding entity.

In an embodiment, the transmission skipping operation performed by lower entities (e.g., the NR RLC entity 623, the NR MAC entity 633, and the NR PHY entity 643) associated with the NR transmission path may include at least one of the following operations.

First, a PHY entity (e.g., an NR PHY entity 643) may identify that the biased mode is activated based on the biased mode indicator. Based on the biased mode indicator and skipUplinkTxDynamic, the NR PHY entity 643 may ignore transmission of a TB on an allocated uplink radio resource (e.g., an uplink grant) even though the uplink radio resource is allocated from the network, so the transmission of the TB may be skipped.

Second, a MAC entity (e.g., the NR MAC entity 633) may exclude data volume of a PDCP entity (e.g., the NR PDCP entity 611) when calculating data volume for the NR transmission path. As such, as the NR MAC entity 633 excludes the data volume of the PDCP entity when calculating the data volume of the NR transmission path, the data volume of the PDCP entity is not considered when a BSR is transmitted, so this may prevent allocating a radio resource corresponding to the data volume of the PDCP entity when the network allocates a radio resource for the NR transmission path.

Third, an RLC entity (e.g., the NR RLC entity 623) may stop uplink data transmission through the NR transmission path and transfer (for example, revert) unprocessed data stored in a buffer of the NR RLC entity 623 to a PDCP entity (e.g., the NR PDCP entity 611) in order to transmit uplink data whose transmission is stopped in the NR transmission path by activation of the biased mode. The NR PDCP entity 611 may transfer data received from the NR RLC entity 623 to an RLC entity (e.g., the LTE RLC entity 631) so that the data is transmitted through a first transmission path (e.g., an LTE transmission path) used in the biased mode.

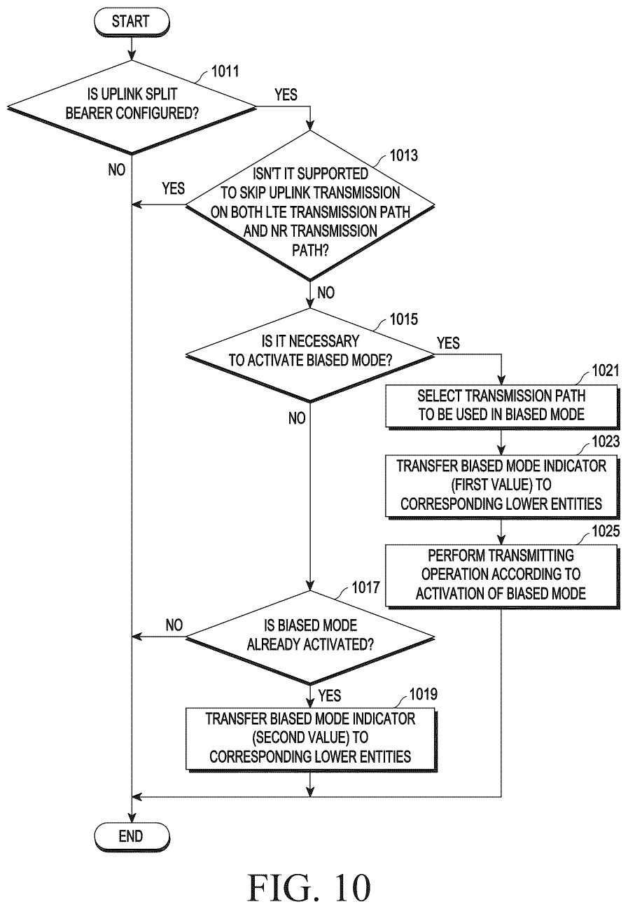

FIG. 10 is a flowchart illustrating an operating process of an electronic device according to an embodiment.

Referring to FIG. 10, an electronic device (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device illustrated in FIG. 10 may be performed by an NR PDCP entity (e.g., an NR PDCP entity 611 in FIG. 6B) included in a protocol stack of the electronic device. In the electronic device, at least one processor may control operations of an NR PDCP entity and the remaining entities (e.g., an LTE RRC entity (e.g., an LTE RRC entity 601 in FIG. 6B), an NR RRC entity (e.g., an NR RRC entity 603 in FIG. 6B), an LTE RLC entity (e.g., an LTE RLC entity 621 in FIG. 6B), an NR RLC entity (e.g., an NR RLC entity 623 in FIG. 6B), an LTE MAC entity (e.g., an LTE MAC entity 631 in FIG. 6B), an NR MAC entity (e.g., an NR MAC entity 633 in FIG. 6B), an LTE PHY entity (e.g., an LTE PHY entity 641 in FIG. 6B), and/or an NR PHY entity (e.g., an NR PHY entity in FIG. 6B). In an embodiment, the at least one processor may include a communication processor (e.g., at least one of a processor 120 in FIG. 1, a first communication processor 212 or a second communication processor 214 in FIG. 2A, or a communication processor 260 in FIG. 2B).

In operation 1011, the NR PDCP entity may identify whether an uplink split bearer is configured in the electronic device. In an embodiment, the NR PDCP entity may determine whether the uplink split bearer is configured in the electronic device based on higher layer signaling (e.g., an RRC reconfiguration message). For example, the NR PDCP entity may identify that the uplink split bearer is configured in the electronic device if information about a physical uplink shared channel (PUSCH) configured for an LTE transmission path and an NR transmission path, PrimaryPath, and ul-DataSplitThreshold whose value is set to another value other than a second value (e.g., infinity) is included in the RRC reconfiguration message. As a result of identification in operation 1011, if the uplink split bearer is not configured in the electronic device (Operation 1011—No), the NR PDCP entity may terminate the corresponding operation without performing any further operations.

As a result of identification in operation 1011, if the uplink split bearer is configured in the electronic device (Operation 1011—Yes), the NR PDCP entity may identify whether it is not supported to skip uplink transmission on both the LTE transmission path and the NR transmission path, which are transmission paths associated with the uplink split bearer in operation 1013. The NR PDCP entity may identify whether it is not supported to skip the uplink transmission on both the LTE transmission path and the NR transmission path based on the RRC reconfiguration message. The NR PDCP entity may identify whether it is not supported to skip the uplink transmission on the LTE transmission path based on skipUplinkDynamic included in the RRC reconfiguration message. For example, if skipUplinkDynamic is set to true, the NR PDCP entity may identify that it is supported to skip the uplink transmission on the LTE transmission path, and if skipUplinkDynamic is not set to true, the NR PDCP entity may identify that it is not supported to skip the uplink transmission on the LTE transmission path. The NR PDCP entity may identify whether it is not supported to skip the uplink transmission on the NR transmission path based on skipUplinkTxDynamic included in the RRC reconfiguration message. For example, if skipUplinkTxDynamic is set to true, the NR PDCP entity may identify that it is supported to skip the uplink transmission on the NR transmission path, and if skipUplinkTxDynamic is not set to true, the NR PDCP entity may identify that it is not supported to skip the uplink transmission on the NR transmission path. As a result of the identification in operation 1013, if it is not supported to skip the uplink transmission on both the LTE transmission path and the NR transmission path (1013—Yes), the NR PDCP entity may terminate the corresponding operation without performing any further operations.

If the uplink split bearer is not configured, or if it is not supported to skip the uplink transmission on both the LTE transmission path and the NR transmission path on the uplink split bearer even though the uplink split bearer is configured, the NR PDCP entity may identify that a biased mode is not supported. If the uplink split bearer is configured, and if it is supported to skip the uplink transmission on at least one of the LTE transmission path and the NR transmission path on the uplink split bearer, the NR PDCP entity may identify that the biased mode is supported.

As a result of the identification in operation 1013, if it is supported to skip the uplink transmission on at least one of the LTE transmission path and the NR transmission path (1013—No), the NR PDCP entity may identity whether it is necessary to activate the biased mode in operation 1015. If the uplink split bearer is configured and it is supported to skip the uplink transmission on at least one of the LTE transmission path and the NR transmission path on the uplink split bearer, the NR PDCP entity may identify that the biased mode is supported, and therefore identify whether it is necessary to activate the biased mode in operation 1015. In an embodiment, the NR PDCP entity may identify whether it is necessary to activate the biased mode based on a trigger condition, or may identify whether it is necessary to activate the biased mode based on an user interaction, or may identify whether it is necessary to activate the biased mode based on higher layer signaling received from a network (e.g., a base station), or may identify whether it is necessary to activate the biased mode based on a combination thereof. An operation in which the NR PDCP entity may identify whether it is necessary to activate the biased mode based on the trigger condition, or may identify whether it is necessary to activate the biased mode based on the user interaction, or may identify whether it is necessary to activate the biased mode based the higher layer signaling received from the network may be implemented to be similar to or substantially the same as that described with reference to FIG. 6B, so a detailed description thereof will be omitted.

As a result of the identification in operation 1015, if it is not necessary to activate the biased mode (1015—No), the NR PDCP entity may identify whether the biased mode is currently activated in operation 1017. As a result of identification in operation 1017, if the biased mode is not currently activated (1017—No), the NR PDCP entity may terminate the corresponding operation without performing any further operations.

As a result of the identification in operation 1017, if the biased mode is currently activated (1017—Yes), there is no need for activating the biased mode, so the NR PDCP entity may set a value of a biased mode indicator to a second value (e.g., 0) to deactivate the biased mode which is currently activated, and transfer the biased mode indicator for which the second value is set to corresponding lower entities in operation 1019. The corresponding lower entities which receive the biased mode indicator set to the second value may identify that the biased mode is deactivated and stop a transmission skip operation which is being performed according to the activation of the biased mode. According to an embodiment, the lower entities which identify that the biased mode is deactivated may stop a timer which is running according to the activation of the biased mode.

As a result of the identification in operation 1015, if it is necessary to activate the biased mode (1015—Yes), the NR PDCP entity may select an uplink data transmission path (e.g., a first transmission path) to be used in the biased mode on at least one of the LTE transmission path and the NR transmission path in operation 1021. The NR PDCP entity may select the uplink data transmission path to be used in the biased mode on the at least one of the LTE transmission path and the NR transmission path based on a capability (e.g., an UE radio capability) of the electronic device, and channel quality, a transmission characteristic, and/or required transmission power on each of the LTE transmission path and the NR transmission path. A scheme by which the NR PDCP entity selects the uplink data transmission path to be used in the biased mode may be implemented to be similar to or substantially the same as that described with reference to FIG. 6B, so a detailed description thereof will be omitted.

In operation 1023, the NR PDCP entity which selects the uplink data transmission path to be used in the biased mode may set a value of a biased mode indicator to a first value (e.g., 0) to activate the biased mode, and transfer the biased mode indicator set to the first value to lower entities which correspond to a transmission path (e.g., a second transmission path) other than the selected transmission path. The corresponding lower entities which receive the biased mode indicator set to the first value may identify that the biased mode is activated, and perform a transmission skip operation in the corresponding lower entities according to the activation of the biased mode. The transmission skip operation performed by the lower entities in the transmission path which is not selected according to the activation of the biased mode may be implemented to be similar to or substantially the same as a transmission skip operation described with reference to FIG. 6B, so a detailed description thereof will be omitted. According to an embodiment, the lower entities which identify that the biased mode is activated may start a timer according to the activation of the biased mode.

The NR PDCP entity may perform a transmitting operation according to the activation of the biased mode in operation 1025. For example, the NR PDCP entity may transfer uplink data of the NR PDCP entity only to an RLC entity (e.g., an LTE RLC entity) corresponding to the selected transmission path.

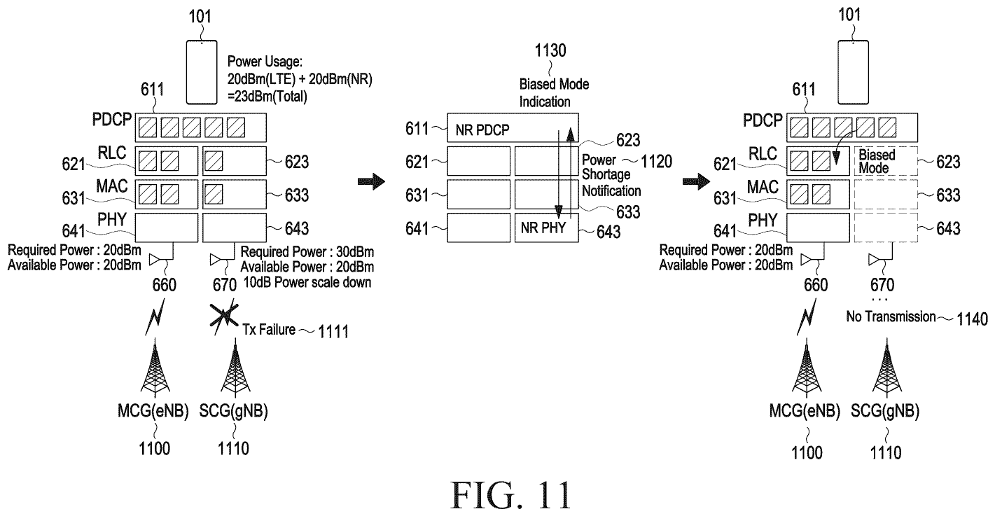

FIG. 11 is a diagram illustrating a transmitting operation of an electronic device, according to an embodiment.

Referring to FIG. 11, an electronic device 101 (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device 101 illustrated in FIG. 11 may be an operating process in a case that a biased mode is activated as a condition, under which transmission power is wasted on a specific transmission path (e.g., an NR transmission path) associated with an uplink split bearer, is satisfied. For example, if a power scale down operation is performed below X_{SCALE}, which is first threshold transmission power, and the transmission operation is performed on the NR transmission path associated with the uplink split bearer, and reduced transmission power for the NR transmission path according to the power scaling down operation is greater than or equal to second threshold transmission power, uplink data transmitted through the NR transmission path does not normally reach a receiving device (e.g., a base station), so the electronic device 101 may predict that transmission failure may occur. For example, if transmission power required on the NR transmission path is 30 dBm, and the power scale down operation is performed by 10 dB based on a DPS scheme and a transmitting operation is performed (for example, if transmission power allocated for the NR transmission path is 20 dBm), it may be difficult for the base station (e.g., a gNB 1110) to normally receive uplink data transmitted from the electronic device 101 through the NR transmission path (for example, transmission failure may occur on the NR transmission path) (Tx failure) (Operation 1111). The electronic device 101 used a total transmission power of 23 dBm for uplink transmission on all transmission paths associated with the uplink split bearer (operation 1113), but transmission power of 20 dBm used for uplink transmission on the NR transmission path among the total transmission power of 23 dBm may be transmission power meaninglessly consumed due to reception failure in the gNB 1110.

In an embodiment, an NR PHY entity 643 may identify that a power shortage situation occurs if transmission power scaled down in the power scale down operation is greater than or equal to second threshold transmission power, or if it is detected that a transmission error greater than or equal to a threshold level occurs while the power scale down operation is performed, or if it is detected that transmission failure greater than or equal to a threshold level occurs. The NR PHY entity 643, which identifies that the power shortage situation occurs, may transfer power shortage notification informing the power shortage situation to an NR PDCP entity 611 (Operation 1120).

The NR PDCP entity 611, which receives the power shortage notification from the NR PHY entity 643, may identify that the power shortage situation occurs on the NR transmission path, and identify that a condition, under which transmission power is wasted on the NR transmission path, is satisfied due to the power shortage situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path (biased mode indication) (Operation 1130). The lower entities 623, 633, and 643 which receive the biased mode indicator set to the first value may identify that the biased mode is activated, and each of the lower entities 623, 633, and 643 which identify that the biased mode is activated may perform a corresponding transmission skip operation (no transmission) (1140). A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

As the biased mode is activated, only a transmitting operation on the LTE transmission path is performed (1150) and an uplink data transmitting operation on the NR transmission path is not performed (1140), thereby preventing unnecessary transmission power consumption through the NR transmission path. Meanwhile, the EN-DC scheme described above is merely illustrative, and those skilled in the art will understand that an embodiment may be applied to an MR-DC scheme including an NE-DC scheme.

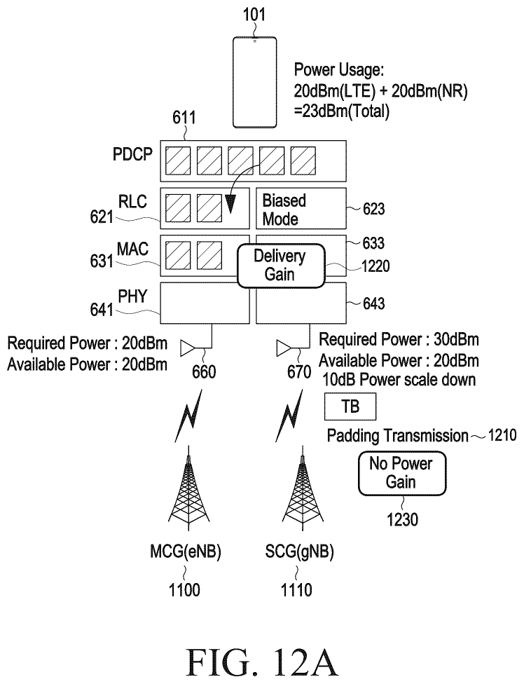

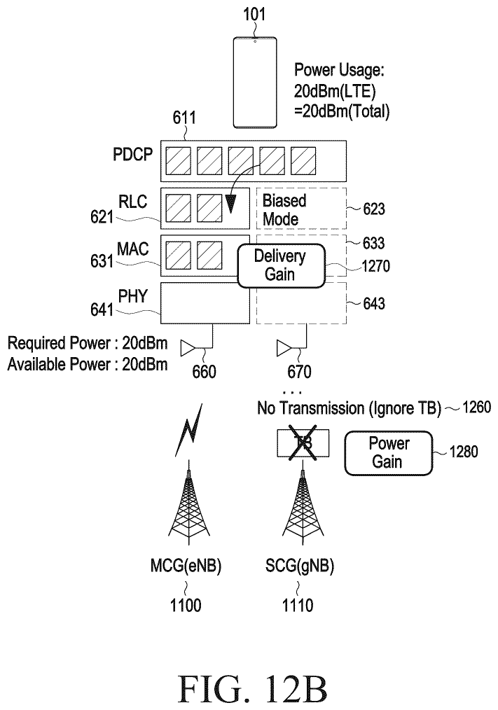

FIG. 12A is a diagram illustrating a transmitting operation of an electronic device, according to an embodiment.

Referring to FIG. 12A, an electronic device 101 (e.g., at least one of a processor 120 in FIG. 1, a first communication processor 212 or a second communication processor 214 in FIG. 2A, or a communication processor 260 in FIG. 2B) may support a frequency range-2 (FR2) band-based EN-DC scheme, and an operating process of the electronic device 101 illustrated in FIG. 12A may be an operating process in a case that it is not supported to skip uplink transmission for an NR transmission path on an uplink split bearer (for example, if skipUplinkTxDynamic is not set to true), and a biased mode is activated as a condition, under which transmission power is wasted on the NR transmission path, is satisfied. In an embodiment, the electronic device 101 may operate based on a frequency range-1 (FR1) band as well as the FR2 band.

The electronic device 101 may select a reception beam used for a data receiving operation on the NR transmission path based on a reference signal (RS) transmitted from an NR base station (e.g., a gNB 1110). Channel quality through the NR transmission path in the selected reception beam may become poor (for example, the channel quality may be less than threshold channel quality) due to relatively fast (for example, greater than or equal to a threshold speed) rotation of the electronic device 101 or a grip of a user of the electronic device 101. In an embodiment, the channel quality may be expressed by at least one of an RSSI, a CQI, an SNR, an SIR, an SINR, RSRP, or RSRQ. So, the electronic device 101 may experience poor channel quality until the electronic device 101 selects a new reception beam to be used on the NR transmission path based on the RS transmitted from the gNB 1110. If the channel quality on the NR transmission path is poor (for example, if the channel quality is less than the threshold channel quality), transmission power required on the NR transmission path is increased through path loss estimation, and thus a power shortage situation may occur. The NR PHY entity 643, which identifies that the power shortage situation occurs, may transfer power shortage notification informing the power shortage situation to the NR PDCP entity 611.

The NR PDCP entity 611, which receives the power shortage notification from the NR PHY entity 643, may identify that the power shortage situation occurs on the NR transmission path, and identify that a condition, under which transmission power is wasted on the NR transmission path, is satisfied due to the power shortage situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path. The lower entities 623, 633, and 643 which receive the biased mode indicator set to the first value may identify that the biased mode is activated, and each of the lower entities 623, 633, and 643 which identify that the biased mode is activated may perform a corresponding transmission skip operation. A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

However, in FIG. 12A, because it is not supported to skip uplink transmission for the NR transmission path (for example, because skipUplinkTxDynamic is not set to true), the NR PHY entity 643 may not skip actual uplink transmission even though the biased mode is activated. If an uplink radio resource for uplink transmission is allocated by the gNB 1110, the NR PHY entity 643 may include padding bits into a payload of a TB generated by the corresponding uplink radio resource and transmit the payload including the padding bits to the gNB 1110 (padding transmission) (1210). As such, because distribution of uplink data through the NR transmission path may be blocked due to activation of the biased mode even though it is not supported to skip the uplink transmission for the NR transmission path, loss of uplink data transmission which may occur on the NR transmission path may be prevented, so a delivery gain may be obtained (1220). However, if it is not supported to skip the uplink transmission for the NR transmission path, padding transmission is performed even though the biased mode is activated, so a gain in terms of transmission power may be limited (no power gain) (1230).

FIG. 12B is a diagram illustrating a transmitting operation of an electronic device, according to an embodiment.

Referring to FIG. 12B, an electronic device 101 (e.g., at least one of a processor 120 in FIG. 1, a first communication processor 212 or a second communication processor 214 in FIG. 2A, or a communication processor 260 in FIG. 2B) may support an FR2 band-based EN-DC scheme, and an operating process of the electronic device 101 illustrated in FIG. 12B may be an operating process in a case that it is supported to skip uplink transmission for an NR transmission path on an uplink split bearer (for example, if skipUplinkTxDynamic is set to true), and a biased mode is activated as a condition, under which transmission power is wasted on the NR transmission path, is satisfied. In an embodiment, the electronic device 101 may operate based on an FR1 band as well as the FR2 band.

The electronic device 101 may select a reception beam used for a data receiving operation on the NR transmission path based on an RS transmitted from an NR base station (e.g., a gNB 1110), and may experience poor channel quality until the electronic device 101 selects a new reception beam to be used on the NR transmission path, as described in FIG. 12A. If the channel quality on the NR transmission path is poor (for example, if the channel quality is less than the threshold channel quality), transmission power required on the NR transmission path is increased through path loss estimation, and thus a power shortage situation may occur. The NR PHY entity 643, which identifies that the power shortage situation occurs, may transfer power shortage notification informing the power shortage situation to the NR PDCP entity 611.

The NR PDCP entity 611, which receives the power shortage notification from the NR PHY entity 643, may identify that the power shortage situation occurs on the NR transmission path, and identify that a condition, under which transmission power is wasted on the NR transmission path, is satisfied due to the power shortage situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path. The lower entities 623, 633, and 643 which receive the biased mode indicator set to the first value may identify that the biased mode is activated, and each of the lower entities 623, 633, and 643 which identify that the biased mode is activated may perform a corresponding transmission skip operation. A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

However, in FIG. 12B, unlike in FIG. 12A, because it is supported to skip uplink transmission for the NR transmission path (for example, because skipUplinkTxDynamic is set to true), the NR PHY entity 643 may skip actual uplink transmission if the biased mode is activated. Even though an uplink radio resource for uplink transmission is allocated by the gNB 1110, the NR PHY entity 643 may ignore transmission of a TB in the corresponding uplink radio resource (ignore TB), so actual uplink data transmission may be skipped (no transmission) (1260). As such, if it is supported to skip uplink transmission for the NR transmission path, a delivery gain may be obtained (1270) because distribution of uplink data through the NR transmission path may be blocked due to activation of the biased mode, and a gain in terms of transmission power (power gain) may be obtained (1280) because actual uplink data transmission is not performed.

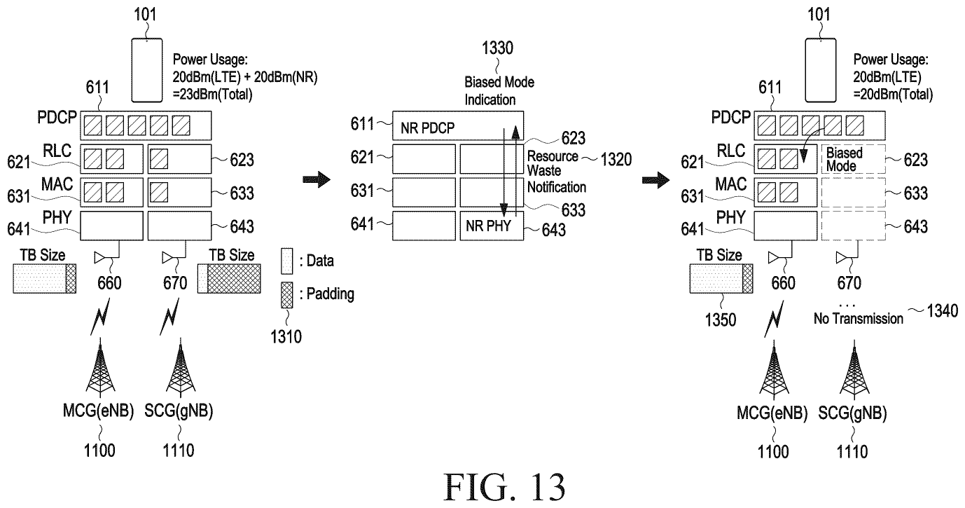

FIG. 13 is a diagram illustrating a transmitting operation of an electronic device, according to an embodiment.

Referring to FIG. 13, an electronic device 101 (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device 101 illustrated in FIG. 13 may be an operating process in a case that a biased mode is activated as a condition, under which transmission power is wasted on a specific transmission path (e.g., an NR transmission path) on an uplink split bearer, is satisfied. In an embodiment, the electronic device 101 may consider that transmission power is wasted on the specific transmission path (e.g., the NR transmission path) associated with the uplink split bearer as the electronic device 101 detects that a situation in which the radio resource is wasted occurs. In an embodiment, when MAC entities (e.g., an LTE MAC entity and an NR MAC entity) associated with transmission paths transmit a BSR, data volume of a PDCP entity (e.g., an NR PDCP entity) is reflected in both the LTE MAC entity and the NR MAC entity, and in conclusion, the data volume of the NR PDCP entity may be considered redundantly.

As such, as the data volume of the NR PDCP entity is redundantly considered in BSRs, an uplink radio resource whose amount exceeds amount of an uplink radio resource which the electronic device 101 actually needs may be allocated from base stations (e.g., an eNB 1100 and a gNB 1110) to the electronic device 101. Uplink data is included in a TB in the uplink radio resource allocated from the base stations, and padding transmission, in which padding bits are included in a payload of the TB and transmitted, may occur (1310) because the uplink radio resource, whose amount is more than amount of an uplink radio resource appropriate for amount of uplink data to be actually transmitted, is allocated, and in this case, the NR PHY entity 643 may consider that transmission power is wasted. In an embodiment, the NR PHY entity 643 may consider that the radio resource is wasted if a size in which the padding bits are included among a TB size of the NR PHY entity 643 is greater than or equal to a threshold percentage (e.g., 50%). In an embodiment, the NR PHY entity 643 may consider that the radio resource is wasted if a ratio of TBs, whose size in which the padding bits are included among the TB size is greater than or equal to the threshold percentage, among all TBs increases during a set time period. In an embodiment, the NR PHY entity 643 may consider that the radio resource is wasted if a set number of TBs, whose size in which the padding bits are included among the TB size is greater than or equal to the threshold percentage, occur continuously. In an embodiment, the NR PHY entity 643 may consider that the radio resource is wasted if a total TB size is greater than or equal to amount of data to be actually transmitted by a threshold size.

If the radio resource is wasted in this way, transmission power required on the NR transmission path is 30 dBm, and the power scale down operation is performed by 10 dB based on a DPS scheme and a transmitting operation is performed (for example, if transmission power allocated for the NR transmission path is 20 dBm), only a portion of the transmission power allocated for the NR transmission path may be used for actual data transmission, so the NR PHY entity 643 may consider the transmission power is wasted.

In an embodiment, when detecting that the waste of transmission power occurs due to the waste of radio resource, the NR PHY entity 643 may transfer resource waste notification informing a radio resource waste situation to the NR PDCP entity 611 (Operation 1320).

The NR PDCP entity 611, which receives the resource waste notification from the NR PHY entity 643, may identify that the resource waste situation occurs on the NR transmission path, and identify that a condition, under which transmission power is wasted on the NR transmission path, is satisfied due to the resource waste situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path (biased mode indication) (Operation 1330). The lower entities 623, 633, and 643 which receive the biased mode indicator set to the first value may identify that the biased mode is activated, and each of the lower entities 623, 633, and 643 which identify that the biased mode is activated may perform a corresponding transmission skip operation (1340). A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

As the biased mode is activated, only a transmitting operation on the LTE transmission path is performed (1350) and an uplink data transmitting operation on the NR transmission path is not performed (no transmission) (1340), thereby preventing unnecessary transmission power consumption through the NR transmission path.

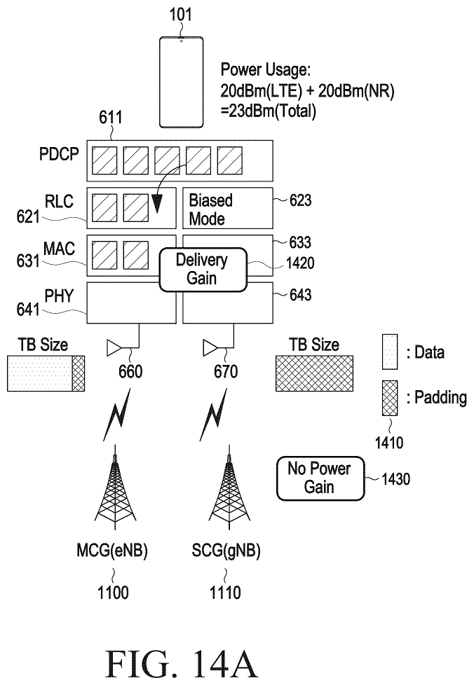

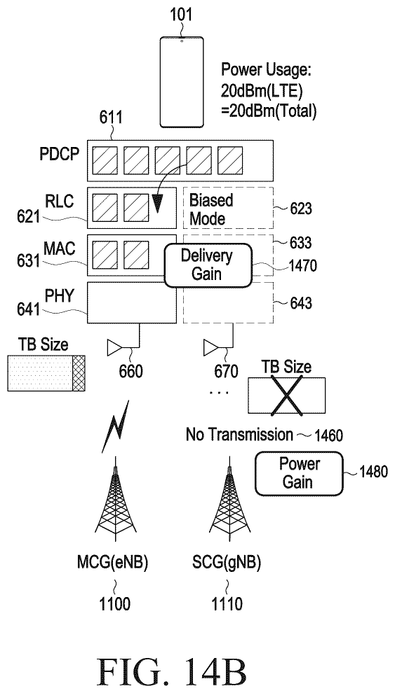

FIG. 14A is a diagram illustrating a transmitting operation of an electronic device, according to an embodiment.

Referring to FIG. 14A, an electronic device 101 (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device 101 illustrated in FIG. 14A may be an operating process in a case that it is not supported to skip uplink transmission for an NR transmission path on an uplink split bearer (for example, if skipUplinkTxDynamic is not set to true), and a biased mode is activated as a condition, under which transmission power is wasted on the NR transmission path, is satisfied.

In the electronic device 101, when MAC entities (e.g., an LTE MAC entity and an NR MAC entity) associated with transmission paths transmit a BSR, data volume of a PDCP entity (e.g., an NR PDCP entity) is reflected in both the LTE MAC entity and the NR MAC entity. In conclusion, the data volume of the NR PDCP entity may be considered redundantly. As such, as the data volume of the NR PDCP entity is redundantly considered in BSRs, an uplink radio resource whose amount exceeds amount of an uplink radio resource which the electronic device 101 actually needs is allocated from base stations (e.g., an eNB 1100 and a gNB 1110) to the electronic device 101. Uplink data is included in a TB in the uplink radio resource allocated from the base stations, and padding transmission, in which padding bits are included in a payload of the TB and transmitted, may occur (1410) because the uplink radio resource, whose amount is more than amount of uplink data to be actually transmitted, is allocated, and in this case, the NR PHY entity 643 may consider that transmission power is wasted.

The NR PHY entity 643, which identifies that the radio resource waste situation occurs, may transfer resource waste notification informing the radio resource waste situation to the NR PDCP entity 611.

The NR PDCP entity 611, which receives the radio resource waste notification from the NR PHY entity 643, may identify that the radio resource waste situation occurs on the NR transmission path, and identify that a condition, under which transmission power is wasted on the NR transmission path, is satisfied due to the resource waste situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path. The lower entities 623, 633, and 643 which receive the biased mode indicator set to the first value may identify that the biased mode is activated, and each of the lower entities 623, 633, and 643 which identify that the biased mode is activated may perform a corresponding transmission skip operation. A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

However, in FIG. 14A, because it is not supported to skip the uplink transmission for the NR transmission path (for example, because skipUplinkTxDynamic is not set to true), the NR PHY entity 643 may not skip actual uplink transmission even though the biased mode is activated. If an uplink radio resource for uplink transmission is allocated by the gNB 1110, the NR PHY entity 643 may include padding bits in a payload of the TB in the corresponding uplink radio resource, and transmit the payload in which the padding bits are included to the gNB 1110 (1410). As such, because distribution of data through the NR transmission path may be blocked due to activation of the biased mode even though it is not supported to skip the uplink transmission for the NR transmission path, loss of uplink data transmission which may occur on the NR transmission path may be prevented, so a delivery gain may be obtained (1420). However, if it is not supported to skip the uplink transmission for the NR transmission path, padding transmission is performed even though the biased mode is activated, so a gain in terms of transmission power may be limited (no power gain) (1430).

FIG. 14B is a diagram illustrating a transmitting operation of an electronic device, according to an embodiment.

Referring to FIG. 14B, an electronic device 101 (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device 101 illustrated in FIG. 14B may be an operating process in a case that it is supported to skip uplink transmission for an NR transmission path on an uplink split bearer (for example, if skipUplinkTxDynamic is set to true), and a biased mode is activated as a condition, under which transmission power is wasted on the NR transmission path, is satisfied.

In the electronic device 101, when MAC entities (e.g., an LTE MAC entity and an NR MAC entity) associated with transmission paths transmit a BSR, data volume of a PDCP entity (e.g., an NR PDCP entity) is reflected in both the LTE MAC entity and the NR MAC entity, and in conclusion, the data volume of the NR PDCP entity may be considered redundantly. As such, as the data volume of the NR PDCP entity is redundantly reflected in BSRs, the NR PHY entity 643, which identifies that the radio resource waste situation occurs, may transfer resource waste notification informing the radio resource waste situation to the NR PDCP entity 611 as described in FIG. 14A.

The NR PDCP entity 611, which receives the radio resource waste notification from the NR PHY entity 643, may identify that the radio resource waste situation occurs on the NR transmission path, and identify that a condition, under which transmission power is wasted on the NR transmission path, is satisfied due to the resource waste situation. The NR PDCP entity 611 may determine to activate the biased mode as the condition, under which the transmission power is wasted on the NR transmission path, is satisfied. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path. The lower entities 623, 633, and 643 which receive the biased mode indicator set to the first value may identify that the biased mode is activated, and each of the lower entities 623, 633, and 643 which identify that the biased mode is activated may perform a corresponding transmission skip operation. A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

However, in FIG. 14B, unlike in FIG. 14A, because it is supported to skip uplink transmission for the NR transmission path (for example, because skipUplinkTxDynamic is set to true), the NR PHY entity 643 may skip actual uplink transmission if the biased mode is activated. Even though an uplink radio resource for uplink transmission is allocated by the gNB 1110, the NR PHY entity 643 may a TB generated by the corresponding uplink radio resource, so actual uplink data transmission may be skipped (no transmission) (1460). As such, if it is supported to skip uplink transmission for the NR transmission path, a delivery gain may be obtained (1470) because distribution of data through the NR transmission path may be blocked due to activation of the biased mode, and a gain in terms of transmission power (power gain) may be obtained (1480) because actual uplink transmission is not performed.

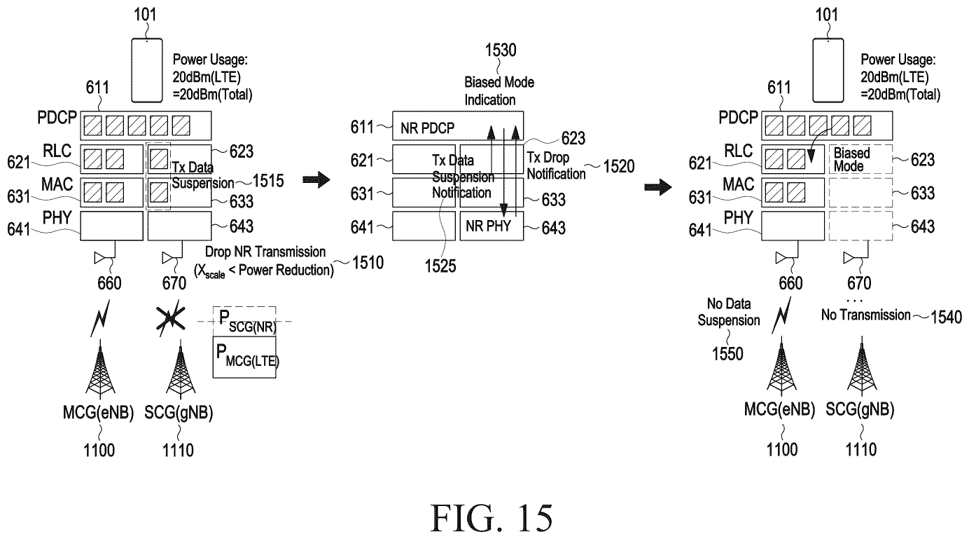

FIG. 15 is a diagram illustrating a transmitting operation of an electronic device, according to an embodiment.

Referring to FIG. 15, an electronic device 101 (e.g., at least one of a processor 120 in FIG. 1, a first communication processor 212 or a second communication processor 214 in FIG. 2A, or a communication processor 260 in FIG. 2B) may support an EN-DC scheme, and an operating process of the electronic device 101 illustrated in FIG. 15 may be an operating process in a case that a biased mode is activated as a condition, under which uplink transmission is stopped (for example, dropped) on a specific transmission path (e.g., an NR transmission path) on an uplink split bearer, is satisfied. In an embodiment, in the electronic device 101, a difference between transmission power actually required on a secondary path (e.g., an NR transmission path) and transmission power allocated to the secondary path exceeds xScale which is a set threshold power difference, uplink transmission may be stopped (drop NR transmission) on the secondary path (Operation 1510). In an embodiment, xScale may be received via higher layer signaling (e.g., AN RRC message). For example, xScale may be received via an RRC reconfiguration message.

If a difference between transmission power actually required on the NR transmission path and transmission power allocated for the NR transmission path exceeds xScale, uplink transmission via the NR PHY entity 643 may be stopped. As uplink transmission via the NR PHY entity 643 is stopped, uplink data of the NR RLC entity 623 and the NR MAC entity 633 on the NR transmission path may not be transmitted, and may still exist in the NR RLC entity 623 and the NR MAC entity 633. As such, as the uplink transmission through the NR PHY entity 643 is stopped, data from the NR RLC entity 623 and the NR MAC entity 633 may not be transmitted to a receiving device (e.g., a gNB 1110) (Tx data suspension) (Operation 1515). In this case, the uplink data of the electronic device 101 is transmitted through the LTE transmission path, but the uplink data of the electronic device 101 is not transmitted through the NR transmission path, so the receiving device may receive non-sequential (for example, not sequentially ordered) uplink date. In this case, even though the receiving device normally receives the uplink data transmitted through the LTE transmission path, the receiving device does not receive the uplink data through the NR transmission path, so the receiving device may not perform an ordering operation for the received uplink data. The receiving device needs to wait until the receiving device receives data which is not received, so processing delay may occur due to this.

If a condition, under which uplink transmission is dropped on the NR transmission path, is satisfied, the NR PHY entity 643 may transfer, to the NR PDCP entity 611, transmission drop notification informing uplink transmission stop situation (Operation 1520). As uplink transmission through the NR PHY entity 643 is stopped, the NR RLC entity 623 and the NR MAC entity 633 may transfer, to the NR PDCP entity 611, Tx data suspension notification informing a transmission data suspension situation (operation 1525).

Upon receiving the transmission drop notification from the NR PHY entity 643 and receiving the Tx data suspension notification from the NR RLC entity 623 and the NR MAC entity 633, the NR PDCP entity 611 may identify that an uplink transmission suspension situation occurs on the NR transmission path, so the NR PDCP entity 611 may determine to activate a biased mode. The NR PDCP entity 611 may select an uplink data transmission path to be used in the biased mode as an LTE transmission path, and transfer a biased mode indicator set to a first value to lower entities 623, 633, and 643 (e.g., an NR RLC entity 623, an NR MAC entity 633, and an NR PHY entity 643 in FIG. 6B) associated with the NR transmission path (biased mode indication) (operation 1530). The lower entities 623, 633, and 643 which receive the biased mode indicator set to the first value may identify that the biased mode is activated, and each of the lower entities 623, 633, and 643 which identify that the biased mode is activated may perform a corresponding transmission skip operation (no transmission) (1540). A transmission skip operation performed in each of the lower entities 623, 633, and 643 may be implemented to be similar to or substantially the same as a transmission skip operation performed in each of lower entities associated with a transmission path other than a transmission path used in a biased mode as described in FIG. 6B, so a detailed description thereof will be omitted.

As the biased mode is activated, only a transmitting operation on the LTE transmission path is performed without suspending data transmission (no data suspension) (operation 1550) and an uplink data transmitting operation on the NR transmission path is not performed (operation 1540), thereby preventing unnecessary transmission power consumption through the NR transmission path.

According to an embodiment of the disclosure, an operating method of an electronic device (e.g., an electronic device 101 in FIG. 1, 2A, 2B, or 6B) may be provided, and the operating method may include selecting one of a transmission path based on a first radio access technology (RAT) and a transmission path based on a second RAT as a first transmission path, which is an uplink data transmission path to be used in the electronic device (e.g., the electronic device 101 in FIG. 1, 2A, 2B, or 6B), for a dual connectivity communication.

According to an embodiment of the disclosure, the operating method may further include performing an operation of stopping uplink data transmission and maintaining uplink control information transmission on a second transmission path other than the first transmission path among the transmission path based on the first RAT and the transmission path based on the second RAT.

According to an embodiment of the disclosure, the operating method may further include performing an operation of transmitting at least one of uplink data or uplink control information on the first transmission path.

According to an embodiment of the disclosure, performing the operation of stopping the uplink data transmission and maintaining the uplink control information transmission on the second transmission path may include causing a medium access control (MAC) entity associated with the second transmission path to generate a buffer status report (BSR) including information associated with amount of uplink data of a radio link control (RLC) entity associated with the second transmission path, from which amount of uplink data of a packet data convergence protocol (PDCP) entity associated with the first transmission path and the second transmission path is excluded.

According to an embodiment of the disclosure, performing the operation of stopping the uplink data transmission and maintaining the uplink control information transmission on the second transmission path may further include transmitting the generated BSR to a base station associated with the second RAT on the second transmission path.

According to an embodiment of the disclosure, performing the operation of stopping the uplink data transmission and maintaining the uplink control information transmission on the second transmission path may include causing a physical (PHY) entity associated with the second transmission path to stop transmission of a transport block (TB) on a radio resource allocated from a base station related to the second RAT.

According to an embodiment of the disclosure, performing the operation of stopping the uplink data transmission and maintaining the uplink control information transmission on the second transmission path may include causing a radio link control (RLC) entity associated with the second transmission path to transfer uplink data of the RLC entity to a packet data convergence protocol (PDCP) entity associated with the first transmission path and the second transmission path.

According to an embodiment of the disclosure, the operating method may further include receiving a radio resource control (RRC) message from at least one of a base station associated with the first RAT or a base station associated with the second RAT.

According to an embodiment of the disclosure, selecting the first transmission path may include identifying whether a set condition is satisfied, based on the received RRC message.

According to an embodiment of the disclosure, selecting the first transmission path may further include selecting the first transmission path, based on identifying that the set condition is satisfied.

According to an embodiment of the disclosure, the set condition may include at least one of a condition in which an uplink split bearer, which corresponds to the transmission path based on the first RAT and the transmission path based on the second RAT, is configured in the electronic device (e.g., the electronic device 101 in FIG. 1, 2A, 2B, or 6B), a condition in which at least one of uplink data transmission on the transmission path based on the first RAT or uplink data transmission on the transmission path based on the second RAT is supported to be stopped, a condition in which a difference between transmission power allocated to a primary path among the transmission path based on the first RAT and the transmission path based on the second RAT and transmission power allocated to a secondary path other than the primary path is less than or equal to a first threshold transmission power and is greater than or equal to a second threshold transmission power, a condition in which the difference between the transmission power allocated to the primary path and the transmission power allocated to the secondary path is greater than or equal to the first threshold transmission power, or a condition in which it is indicated to perform an operation of transmitting at least one of the uplink data or the uplink control information on the first transmission path, and stopping the uplink data transmission and maintaining the uplink control information transmission on the second first transmission path.

According to an embodiment of the disclosure, selecting the first transmission path may include identifying whether a set condition is satisfied, and selecting the first transmission path, based on identifying that the set condition is satisfied, and the set condition may include at least one of a condition in which an error rate measured on at least one of the transmission path based on the first RAT and the transmission path based on the second RAT is greater than or equal to a threshold error rate, a condition in which a number of non-acknowledgements (NACKs), which are received on at least one of the transmission path based on the first RAT and the transmission path based on the second RAT during a set time period, is greater than or equal to a threshold number, a condition for outputting a notification message notifying to perform an operation of transmitting at least one of the uplink data or the uplink control information on the first transmission path, and stopping the uplink data transmission and maintaining the uplink control information transmission on the second transmission path, or a condition for receiving an input requesting to perform an operation of transmitting at least one of the uplink data or the uplink control information on the first transmission path, and stopping the uplink data transmission and maintaining the uplink control information transmission on the second transmission path.

According to an embodiment of the disclosure, the operating method may further include adjusting amount of uplink data for the first transmission path and amount of uplink data for the second transmission path corresponding to a set ratio.

According to an embodiment of the disclosure, the operating method may further include performing a transmitting operation on the first transmission path based on the adjusted amount of uplink data for the first transmission path.

According to an embodiment of the disclosure, the operating method may further include performing a transmitting operation on the second transmission path based on the adjusted amount of uplink data for the second transmission path.

According to an embodiment of the disclosure, an electronic device for supporting dual connectivity and an operating method thereof may be provided.

According to an embodiment of the disclosure, an electronic device for controlling transmission paths in an uplink split bearer environment and an operating method thereof may be provided.

According to an embodiment of the disclosure, an electronic device for controlling transmission paths based on transmission power in an uplink split bearer environment and an operating method thereof may be provided.

According to an embodiment of the disclosure, an electronic device for stopping uplink data transmission through a specific transmission path in an uplink split bearer environment and an operating method thereof may be provided.

What is claimed is:

1. An electronic device comprising:
communication circuitry;
one or more processors including processing circuitry; and
memory storing instructions that, when executed by the one or more processors individually or collectively, cause the electronic device to:
select one of a transmission path based on a first radio access technology (RAT) and a transmission path based on a second RAT as a first transmission path, wherein the first transmission path is an uplink data transmission path to be used in the electronic device for a dual connectivity communication,
perform, via the communication circuitry, an operation of stopping uplink data transmission and maintaining uplink control information transmission on a second transmission path other than the first transmission path among the transmission path based on the first RAT and the transmission path based on the second RAT, and
perform, via the communication circuitry, an operation of transmitting at least one of uplink data or uplink control information on the first transmission path.

2. The electronic device of claim 1, wherein the instructions, when executed by the one or more processors individually or collectively, cause the electronic device to:
cause a medium access control (MAC) entity associated with the second transmission path to generate a buffer status report (BSR) comprising information associated with an amount of uplink data of a radio link control (RLC) entity associated with the second transmission path, and
wherein the BSR excludes an amount of uplink data of a packet data convergence protocol (PDCP) entity associated with the first transmission path and the second transmission path.

3. The electronic device of claim 1, wherein the instructions, when executed by the one or more processors individually or collectively, cause the electronic device to:
cause a physical (PHY) entity associated with the second transmission path to stop transmission of a transport block (TB) on a radio resource allocated from a base station related to the second RAT.

4. The electronic device of claim 1,
wherein the instructions, when executed by the one or more processors individually or collectively, cause the electronic device to: cause a radio link control (RLC) entity associated with the second transmission path to transfer uplink data of the RLC entity to a packet data convergence protocol (PDCP) entity associated with the first transmission path and the second transmission path.

5. The electronic device of claim 1, wherein the instructions, when executed by the one or more processors individually or collectively, cause the electronic device to:
receive, via the communication circuitry, a radio resource control (RRC) message from at least one of a base station associated with the first RAT or a base station associated with the second RAT,
based on the received RRC message, identify whether a set condition is satisfied, and
based on identifying that the set condition is satisfied, select the first transmission path.

6. The electronic device of claim 1, wherein the instructions, when executed by the one or more processors individually or collectively, cause the electronic device to:
identify whether a set condition is satisfied, and
based on identifying that the set condition is satisfied, select the first transmission path, and
wherein the set condition comprises at least one of:
a condition in which an error rate measured on at least one of the transmission path based on the first RAT and the transmission path based on the second RAT is greater than or equal to a threshold error rate,
a condition in which a number of non-acknowledgements (NACKs), which are received on at least one of the transmission path based on the first RAT and the transmission path based on the second RAT during a set time period via the communication circuitry, is greater than or equal to a threshold number, or
a condition in which a battery capacity is less than or equal to a threshold battery capacity.

7. The electronic device of claim 1, further comprising:
a display module,
wherein the instructions, when executed by the one or more processors individually or collectively, cause the electronic device to:
identify whether a set condition is satisfied, and
based on identifying that the set condition is satisfied, select the first transmission path, and
wherein the set condition includes at least one of:
a condition for outputting, via the display module, a notification message notifying to perform an operation of transmitting at least one of the uplink data or the uplink control information on the first transmission path, and stopping the uplink data transmission and maintaining the uplink control information transmission on the second transmission path, or
a condition for receiving, via the display module, an input requesting to perform an operation of transmitting at least one of the uplink data or the uplink control information on the first transmission path, and stopping the uplink data transmission and maintaining the uplink control information transmission on the second transmission path.

8. The electronic device of claim 1, wherein the instructions, when executed by the one or more processors individually or collectively, cause the electronic device to:
adjust an amount of uplink data for the first transmission path and an amount of uplink data for the second transmission path corresponding to a set ratio,
perform, via the communication circuitry, a transmitting operation on the first transmission path based on the adjusted amount of uplink data for the first transmission path, and
perform, via the communication circuitry, a transmitting operation on the second transmission path based on the adjusted amount of uplink data for the second transmission path.

9. A method performed by an electronic device, the method comprising:
selecting one of a transmission path based on a first radio access technology (RAT) and a transmission path based on a second RAT as a first transmission path, wherein the first transmission path is an uplink data transmission path to be used in the electronic device for a dual connectivity communication;
performing an operation of stopping uplink data transmission and maintaining uplink control information transmission on a second transmission path other than the first transmission path among the transmission path based on the first RAT and the transmission path based on the second RAT; and
performing an operation of transmitting at least one of uplink data or uplink control information on the first transmission path.

10. The method of claim 9, wherein the performing the operation of stopping the uplink data transmission and maintaining the uplink control information transmission on the second transmission path comprises causing a medium access control (MAC) entity associated with the second transmission path to generate a buffer status report (BSR) including information associated with an amount of uplink data of a radio link control (RLC) entity associated with the second transmission path,
wherein the BSR excludes an amount of uplink data of a packet data convergence protocol (PDCP) entity associated with the first transmission path and the second transmission path.

11. The method of claim 9, wherein the performing the operation of stopping the uplink data transmission and maintaining the uplink control information transmission on the second transmission path comprises causing a physical (PHY) entity associated with the second transmission path to stop transmission of a transport block (TB) on a radio resource allocated from a base station related to the second RAT.

12. The method of claim 9, wherein the performing the operation of stopping the uplink data transmission and maintaining the uplink control information transmission on the second transmission path comprises causing a radio link control (RLC) entity associated with the second transmission path to transfer uplink data of the RLC entity to a packet data convergence protocol (PDCP) entity associated with the first transmission path and the second transmission path.

13. The method of claim 9 further comprising receiving a radio resource control (RRC) message from at least one of a base station associated with the first RAT or a base station associated with the second RAT,
wherein the selecting the first transmission path comprises:
identifying whether a set condition is satisfied, based on the received RRC message; and
selecting the first transmission path, based on identifying that the set condition is satisfied.

14. The method of claim 9, wherein the selecting the first transmission path comprises:
identifying whether a set condition is satisfied; and
selecting the first transmission path, based on identifying that the set condition is satisfied,
wherein the set condition comprises at least one of:
a condition in which an error rate measured on at least one of the transmission path based on the first RAT and the transmission path based on the second RAT is greater than or equal to a threshold error rate,
a condition in which a number of non-acknowledgements (NACKs), which are received on at least one of the transmission path based on the first RAT and the transmission path based on the second RAT during a set time period, is greater than or equal to a threshold number,
a condition for outputting a notification message notifying to perform an operation of transmitting at least one of the uplink data or the uplink control information on the first transmission path, and stopping the uplink data transmission and maintaining the uplink control information transmission on the second transmission path, or
a condition for receiving an input requesting to perform an operation of transmitting at least one of the uplink data or the uplink control information on the first transmission path, and stopping the uplink data transmission and maintaining the uplink control information transmission on the second transmission path.

15. An electronic device comprising:
communication circuitry;
one or more processors comprising processing circuitry; and, memory storing instructions that, when executed by the one or more processors individually or collectively, cause the electronic device to:
based on a designated condition being satisfied:
select one of a transmission path based on a first radio access technology (RAT) and a transmission path based on a second RAT as a first transmission path, wherein the first transmission path is an uplink data transmission path to be used in the electronic device for a dual connectivity communication,
perform, via the communication circuitry, an operation of stopping uplink data transmission and maintaining uplink control information transmission on a second transmission path other than the first transmission path among the transmission path based on the first RAT and the transmission path based on the second RAT, and
perform, via the communication circuitry, an operation of transmitting at least one of uplink data or uplink control information on the first transmission path,
based on the designated condition being unsatisfied:
based on an amount of the uplink data, transmit the uplink data by using the transmission path based on the first RAT and the transmission path based on the second RAT, or by using a primary path among the transmission path based on the first RAT and the transmission path based on the second RAT.

16. The electronic device of claim 2, wherein the instructions, when executed by the one or more processors individually or collectively, cause the electronic device to:
transmit, to a base station related to the second RAT via the communication circuitry, the generated BSR on the second transmission path.

17. The electronic device of claim 5, wherein the set condition comprises at least one of:
a condition in which an uplink split bearer, which corresponds to the transmission path based on the first RAT and the transmission path based on the second RAT, is configured in the electronic device,
a condition in which at least one of uplink data transmission on the transmission path based on the first RAT or uplink data transmission on the transmission path based on the second RAT is supported to be stopped,
a condition in which a difference between transmission power allocated to a primary path among the transmission path based on the first RAT and the transmission path based on the second RAT and transmission power allocated to a secondary path other than the primary path is less than or equal to a first threshold transmission power and is greater than or equal to a second threshold transmission power,
a condition in which the difference between the transmission power allocated to the primary path and the transmission power allocated to the secondary path is greater than or equal to the first threshold transmission power, or
a condition in which it is indicated to perform an operation of transmitting at least one of the uplink data or the uplink control information on the first transmission path, and stopping the uplink data transmission and maintaining the uplink control information transmission on the second first transmission path.

18. The method of claim 10, wherein the performing the operation of stopping the uplink data transmission and maintaining the uplink control information transmission on the second transmission path further comprises:
transmitting, to a base station related to the second RAT, the generated BSR on the second transmission path.

19. The method of claim 13, wherein the set condition comprises at least one of:
a condition in which an uplink split bearer, which corresponds to the transmission path based on the first RAT and the transmission path based on the second RAT, is configured in the electronic device,
a condition in which at least one of uplink data transmission on the transmission path based on the first RAT or uplink data transmission on the transmission path based on the second RAT is supported to be stopped,
a condition in which a difference between transmission power allocated to a primary path among the transmission path based on the first RAT and the transmission path based on the second RAT and transmission power allocated to a secondary path other than the primary path is less than or equal to a first threshold transmission power and is greater than or equal to a second threshold transmission power,
a condition in which the difference between the transmission power allocated to the primary path and the transmission power allocated to the secondary path is greater than or equal to the first threshold transmission power, or
a condition in which it is indicated to perform an operation of transmitting at least one of the uplink data or the uplink control information on the first transmission path, and stopping the uplink data transmission and maintaining the uplink control information transmission on the second first transmission path.

20. The method of claim 9, further comprising:
adjusting amount of uplink data for the first transmission path and amount of uplink data for the second transmission path corresponding to a set ratio;
performing a transmitting operation on the first transmission path based on the adjusted amount of uplink data for the first transmission path; and
performing a transmitting operation on the second transmission path based on the adjusted amount of uplink data for the second transmission path.
